(19) United States
(12) Patent Application Publication
(10) Pub. No.: US 2020/0225052 A1
(43) Pub. Date: Jul. 16, 2020

(54) COMMUNICATION CONTROL DEVICE, COMMUNICATION CONTROL METHOD, AND COMPUTER READABLE MEDIUM

(71) Applicant: Mitsubishi Electric Corporation, Tokyo (JP)

(72) Inventor: Teruko FUJII, Tokyo (JP)

(73) Assignee: Mitsubishi Electric Corporation, Tokyo (JP)

(21) Appl. No.: 16/647,849

(22) PCT Filed: Nov. 16, 2017
(86) PCT No.: PCT/JP2017/041240

§ 371 Date: Mar. 16, 2020

(51) Int. Cl. G01C 21/34; G01C 21/36; G06F 9/54

(52) U.S. Cl. CPC G01C 21/3461; G06F 9/541; G01C 21/3492; G01C 21/3605

(57) ABSTRACT

A communication control device (7) is mounted on a moving body in which a plurality of application programs to communicate with an external device are deployed. A scheduling unit (403) schedules, for each of the application programs, using a position on a traveling route of the moving body, a communication timing at which each of the application programs communicates with the external device, based on a communication distance cycle and the traveling route, the communication distance cycle being a distance cycle prescribed for each of the application programs and applicable when each of the application programs communicates with the external device. The timing process unit (404) determines, for each of the application programs, whether or not the moving body has arrived at a position of the communication timing, and when the moving body arrives at the position of the communication timing for any of the application programs, notifies a corresponding application program that the communication timing has come.

### TECHNICAL FIELD

The present invention relates to a communication control device, a communication control method, and communication control program.

### BACKGROUND ART

For example, in Patent Literature 1, a communication control device is installed in a server. And also, in Patent Literature 1, when a mobile communication device mounted on a moving body, such as an automobile, starts communication, the mobile communication device transmits to the communication control device, information, such as a current position, a destination, and a route of the moving body. The communication control device also acquires from a content server, a point .at which content data needs to be used and size of the content data. The communication control device further determines a communication schedule considering a communication inexecutable zone, such as a tunnel, so that the mobile communication device completes data receiving before the moving body arrives at a point at which the content data needs to be delivered. The communication control device also transmits to the mobile communication device, the determined communication schedule. Then, the mobile communication device receives the content data from the content server along the received communication schedule. This allows a moving body to receive content data that needs to be used at a certain point before the moving body arrives at such point.

Patent Literature 2 proposes a method that identifies a communication inexecutable area, such as a tunnel, based on a map, and acquires, in advance, data necessary in that area before entering such communication inexecutable area. Patent Literature 2 also proposes a line switching method that preferentially uses a high-speed communication line if the high-speed communication line is available.

### CITATION LIST

### Patent Literature

Patent Literature 1: JP 5430235

Patent Literature 2: JP 2004-193995 A

### SUMMARY OF INVENTION

### Technical Problem

When being installed in a content server, a conventional communication control device determines communication schedules of a plurality of moving bodies. Therefore, there has been a problem that a conventional method requires an expensive server device that allows high-speed determination on communication schedules of a large number of moving bodies.

When a communication control device is installed in a moving body, it is also necessary to change a compression ratio for each, for example, image or audio application program (hereinafter referred to also as, an application). Therefore, there has been a problem that the conventional method needs to realize different communication control means for each application.

The change in the compression ratio is, for example, a change in a MPEG rate or the like. When the communication control device is installed in the moving body, it is necessary to reduce a total volume of data to be transmitted (that is, to raise the compression ratio) by reducing image or audio quality. And, it is necessary for the communication control device installed in the moving body to complete data downloading before arriving at a zone where communication cannot be carried out. However, since a function to make such change in a compression ratio of data differs (in, for example, how far it can be compressed or whether a compression function is included in the first place) depending on an application, it is necessary to carry out communication for each application in order to communicate earlier.

Therefore, the conventional method has problems as described below:

1. When a communication control device is installed in a moving body, a function to handle a communication inexecutable zone needs to be deployed in each application.

1.1. Accordingly, a development cost is necessary for each application for the function to handle the communication inexecutable zone.

1.2. Also, a processing volume in executing the function to handle the communication inexecutable zone is large (because such function acts for each application). Accordingly, it is necessary for an in-vehicle device to have a high-performance central processing unit (CPU) and a large capacity of memory.

2. When the communication control device is installed in a server, it is necessary for the server to be high-performance =expensive equipment.

A main objective of the present invention is to solve these problems. More specifically, the main objective of the present invention is to eliminate necessity of performing communication control for each application when a communication control device is mounted on a moving body.

### Solution to Problem

A communication control device according to the present invention is a communication control device that is mounted on a moving body in which a plurality of application programs to communicate with an external device are deployed, and includes:

a scheduling unit to schedule for each of the application programs, using a position on a traveling route of the moving body, a communication timing at which each of the application programs communicates with the external device, based on a communication distance cycle and the traveling route, the communication distance cycle being a distance cycle prescribed for each of the application programs and applicable when each of the application programs communicates with the external device; and

a timing process unit to determine for each of the application programs, whether or not the moving body has arrived at a position of the communication timing, and when the moving body arrives at the position of the communication timing for any of the application programs, to notify a corresponding application program that the communication timing has come.

### Advantageous Effects of Invention

According to the present invention, a communication control device mounted on a moving body carries out communication control for a plurality of applications, and thus it is possible to eliminate necessity of performing communication control for each of the applications.

### BRIEF DESCRIPTION OF DRAWINGS

FIG. 1 is a diagram illustrating an example of a system configuration in which a communication control device operates according to Embodiment 1.

FIG. 2 is a diagram illustrating an example of an internal configuration of a moving body according to Embodiment 1.

FIG. 3 is a diagram illustrating an example of a hardware configuration of the communication control device according to Embodiment 1.

FIG. 4 is a diagram illustrating an example of a functional configuration of the communication control device according to Embodiment 1.

FIG. 5 is a diagram illustrating an example of a database configuration of a route storage unit according to Embodiment 1.

FIG. 6 is a diagram illustrating an example of a database configuration of a communication request storage unit according to Embodiment 1.

FIG. 7 is a diagram illustrating an example of a database configuration of a schedule storage unit according to Embodiment 1.

FIG. 8 is a diagram illustrating an example of a database configuration of a position information storage unit according to Embodiment 1.

FIG. 9 is a diagram illustrating an example of a data configuration of a communication timing notice according to Embodiment 1.

FIG. 10 is a flowchart illustrating an example of operation of an in-vehicle LAN communication unit according to Embodiment 1.

FIG. 11 is a flowchart illustrating an example of operation of a communication request registration unit according to Embodiment 1.

FIG. 12 is a flowchart illustrating an example of operation of a scheduling unit according to Embodiment 1.

FIG. 13 is a flowchart illustrating an example of operation of a timing process unit according to Embodiment 1.

FIG. 14 is a flowchart illustrating the example of the operation of the timing process unit according to Embodiment 1.

FIG. 15 is a flowchart illustrating an example of operation of a route registration unit according to Embodiment 1.

FIG. 16 is a flowchart illustrating details of a process of step S1207 according to Embodiment 1.

FIG. 17 is a flowchart illustrating the details of the process of step S1207 according to Embodiment 1.

FIG. 18 is a flowchart illustrating details of a process of step S1208 according to Embodiment 1.

FIG. 19 is a diagram illustrating an example of a database configuration of a schedule storage unit according to Embodiment 2.

FIG. 20 is a flowchart illustrating an example of operation of a timing process unit according to Embodiment 2.

FIG. 21 is a flowchart illustrating the example of the operation of the timing process unit according to Embodiment 2.

FIG. 22 is a flowchart illustrating an example of operation of a scheduling unit according to Embodiment 2.

FIG. 23 is a flowchart illustrating the example of the operation of the scheduling unit according to Embodiment 2.

FIG. 24 is a flowchart illustrating details of a process of step S1915 according to Embodiment 2.

FIG. 25 is a flowchart illustrating the details of the process of step S1915 according to Embodiment 2.

FIG. 26 is a diagram illustrating an example of a traveling route according to Embodiment 1.

FIG. 27 is a diagram illustrating a schema of operation of the communication control device according to Embodiment 1.

FIG. 28 is a diagram illustrating a schema of operation of a communication control device according to Embodiment 2.

FIG. 29 is a diagram illustrating an example of a traveling route according to Embodiment 2.

### DESCRIPTION OF EMBODIMENTS

Hereinafter, embodiments of the present invention will be explained with drawings. In descriptions of embodiments below and the drawings, a part denoted by a same reference sign indicates a same or corresponding part.

### Embodiment 1

### Description of Configuration

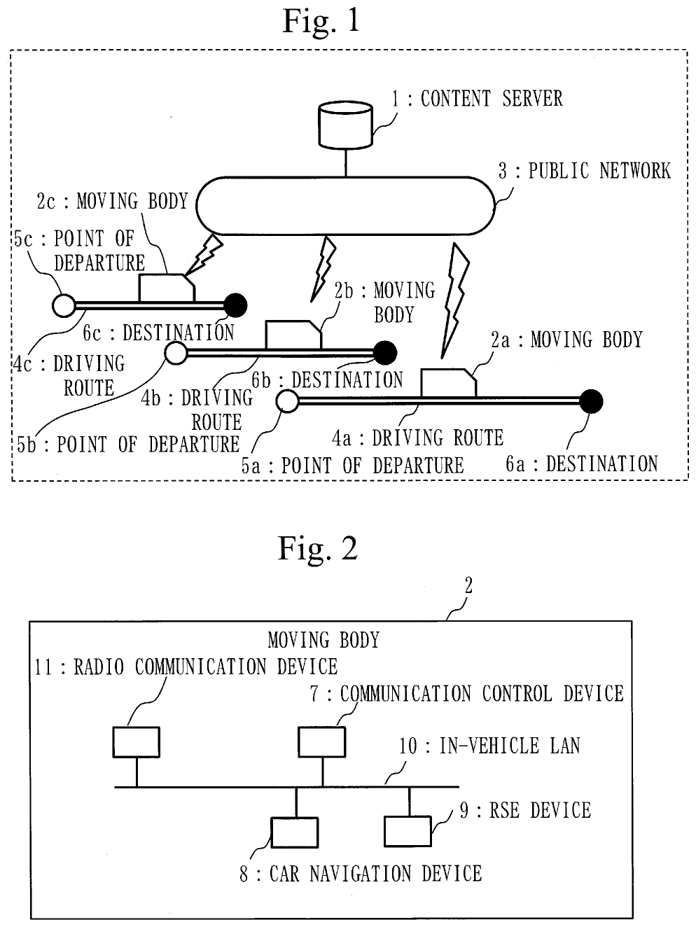

FIG. 1 is a diagram of a system configuration illustrating an entire system in which a communication control device operates according to the present embodiment.

In FIG. 1, a content server 1 is a server device that transmits information related to a position of a moving body in accordance with a request from the moving body.

Moving bodies 2a to 2c are moving bodies, such as automobiles, that travel in accordance with pre-determined driving routes. Note that, if it is not necessary to distinguish among the moving bodies 2a to 2c, the moving body is called simply a moving body 2.

A public network 3 is an existing public communication network composed of a mobile phone network, Internet, and the like.

Driving routes 4a to 4c are traveling routes to destinations determined at points of departure when each of the moving bodies 2a to 2c starts to travel.

Points of departure 5a to 5c are points of departure of each of the moving bodies 2a to 2c.

Destinations 6a to 6c are destinations of each of the moving bodies 2a to 2c.

FIG. 2 is a configuration diagram illustrating an internal device configuration of the moving body 2 in which the communication control device operates according to the present embodiment.

In FIG. 2, the communication control device 7 provides a car navigation device or a rear seat entertainment (RSE) device with data acquired by communication with the content server 1. Operation performed by the communication control device 7 corresponds to a communication control method and a communication control program.

The car navigation device 8 grasps a current position by a global positioning system (GPS), and also determines a driving route of a moving body using map information.

The RSE device 9 is an entertainment device that is installed in a rear seat and provides a passenger in the rear seat with services such as information provision.

Applications run in the car navigation device 8 and the RSE device 9. An application other than these applications may also run in the moving body 2. In other words, a plurality of applications are deployed in the moving body 2.

An in-vehicle local area network (LAN) 10 is a LAN that realizes communication among various devices of the moving bodies 2a to 2c.

A radio communication device 11 is used for each device connected with the content server 1 and the in-vehicle LAN 10 to communicate via the public network 3, using a 3G line, a LTE (a registered trademark) line, and the like.

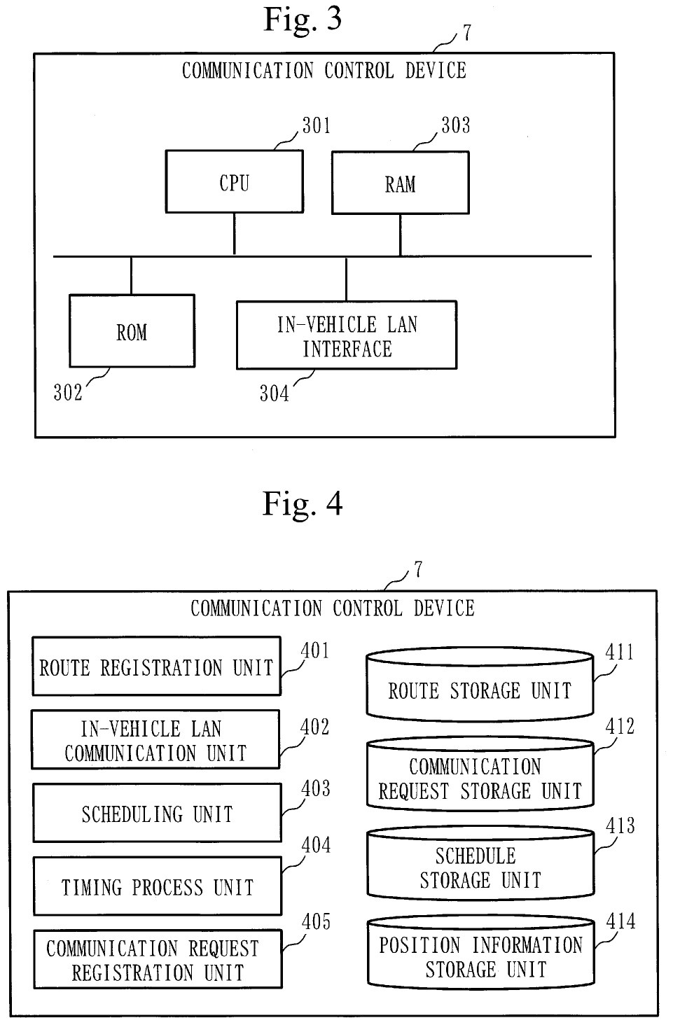

FIG. 3 is a hardware configuration diagram of the communication control device 7 according to the present embodiment.

In FIG. 3, a CPU 301 is a processor that processes operation of the communication control device 7 by software.

A read-only memory (ROM) 302 is a storage device that stores the software for the communication control device 7.

A random-access memory (RAM) 303 is a storage device to which the software that runs in the CPU 301 is loaded from the ROM 302.

The ROM 302 stores programs that realize functions of a route registration unit 401, an in-vehicle LAN communication unit 402, a scheduling unit 403, a timing process unit 404, and a communication request registration unit 405, as described later. These programs are loaded from the ROM 302 to the RAM 303.

Then, a processor 901 executes these programs, and operates the route registration unit 401, the in-vehicle LAN communication unit 402, the scheduling unit 403, the timing process unit 404, and the communication request registration unit 405, as described later.

An in-vehicle LAN interface 304 is a communication interface to communicate with the car navigation device 8 or the RSE device 9 via the in-vehicle LAN 10.

Before explaining details of a functional configuration of the communication control device 7 according to the present embodiment, a schema of the operation of the communication control device 7 will be explained.

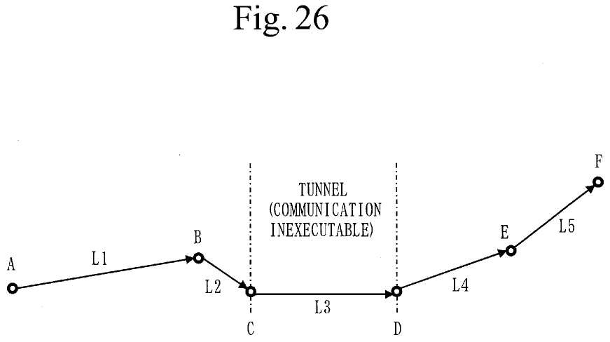

Here, it is assumed that a driving route of a moving body 2 on which the communication control device 7 is mounted is a route illustrated in FIG. 26.

Also, it is assumed that an application 1 and an application 2 are deployed in the moving body 2.

The driving route of the moving body 2 includes a tunnel. In the tunnel, none of the applications deployed in the moving body 2 can communicate with an external device, such as the content server 1.

When the moving body 2 travels from point A to point F, the communication control device 7 adjusts a communication timing of each of the applications so that communication to be carried out in a tunnel (L3) area is carried out in L1 to L2 before such area.

Note that it is assumed that the application 1 acquires from the Internet, data regarding a current position every time the moving body 2 moves forward 500 meters.

Note that it is also assumed that the application 2 acquires from the Internet, the data regarding the current position every time the moving body 2 moves forward five kilometers.

A distance cycle for these applications to acquire the data regarding the current position is called a communication distance cycle.

1. Basic Operation

A. Operation at Time of Activation:

Each of the applications registers a communication distance cycle in the communication control device 7. The application 1 registers a communication distance cycle of every 500 meters, and the application 2 registers a communication distance cycle of every five kilometers.

B. Timing Adjustment:

Upon acquiring information on the driving route of the moving body 2, the communication control device 7 checks whether or not there is a communication inexecutable zone. Upon finding L3 in FIG. 26, the communication control device 7 revises a communication distance cycle of a communication executable zone just before L3.

More specifically, in Embodiment 1, the communication control device 7 revises the communication distance cycle of L2 as calculated by (distance of L2/(distance of L2+distance of L3))×communication distance cycle of application.

Alternatively, in Embodiment 2, the communication control device 7 sets in L2, a communication distance cycle of L3 concurrently with the original communication distance cycle of L2.

Provided, however, that, if L2 is short, the communication control device 7 goes further back to L1 to L2 to revise cycles therein.

C. Communication Operation:

C-1: Normal Zone

The communication control device 7 generates from point A, a position at which each of the applications needs to communicate, along the information on the driving route. The communication control device 7 periodically (for example, at intervals of one second) receives data on a current position of the moving body 2 from a GPS. Therefore, the communication control device 7 calculates travel distance after previous communication every one second for each of the applications (calculates as “accumulated travel distance”). When the moving body 2 moves forward a distance of the communication distance cycle of each of the applications (500 meters or five kilometers), the communication control device 7 notifies the application that it is a communication timing. When being notified by the communication control device 7 that it is the communication timing, the application acquires data on the current position from the Internet.

C-2: Zone Just Before Tunnel

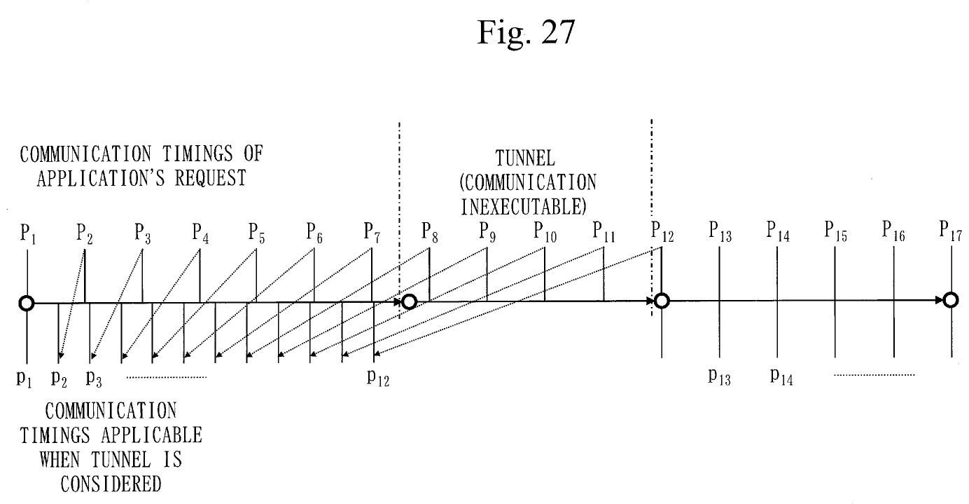

The communication control device 7 transmits the application the communication timing in a distance cycle as revised in “B. Timing Adjustment”. The application acquires the data earlier. In other words, the application acquires data that is associated with a farther position at which the moving body 2 has not arrived yet. In an example of FIG. 27, if there is no tunnel, when the moving body 2 arrives at position P1, the application acquires data on P1. And, when the moving body 2 arrives at position P2, the application acquires data on P2. In a same way, when the moving body 2 arrives at position P3, the application receives data on P3. With the communication timing applicable when the tunnel is considered, when the moving body 2 arrives at position p1, the application acquires data on P1. And, when the moving body 2 arrives at position p2, the application acquires data on P2. Further, when the moving body 2 arrives at position p3, the application acquires data on P3. In this way, the communication control device 7, considering a communication inexecutable zone, revises a communication timing so that data being associated with a farther position at which the moving body 2 has not arrived yet can be acquired. Then, based on the revised communication timing, the communication control device 7 notifies an application of each data that needs to be acquired and an acquisition position (p₁ to p₁₂) of each data.

The application acquires data on the farther position from the Internet at a position notified by the communication control device 7.

2. Additional More Complicated Operation

(1) Handling of Application That Runs in Time Cycle

Here, the example in which data is acquired every 500 meters and every five kilometers is provided for the application 1 and the application 2. However, depending on an application, specifications under which the application runs in a 30-second cycle or in a one-minute cycle can be considered. For such application, the communication control device 7 calculates a distance interval at which communication needs to be carried out for each link, based on a scheduled velocity that is set for each link. Then, the communication control device 7 notifies the application 1 and the application 2 of data that needs to be acquired and an acquisition position of each of the data.

(2) Restriction on Maximum Traffic per Second

If a same timing is applicable to cycles of a plurality of applications, traffic amount increases. Therefore, congestion occurs in a communication line. Accordingly, when implementing “C. Communication Operation” every one second, the communication control device 7 restricts number of applications to which a communication timing is notified by “number of communication events”. For an application of low priority, “C. Communication Operation” is implemented one second after a next GPS position is received. Note that this restriction is placed not by actual traffic amount, but by number of applications that carry out communication.

(3) Revision of Timing Just Before Intersection

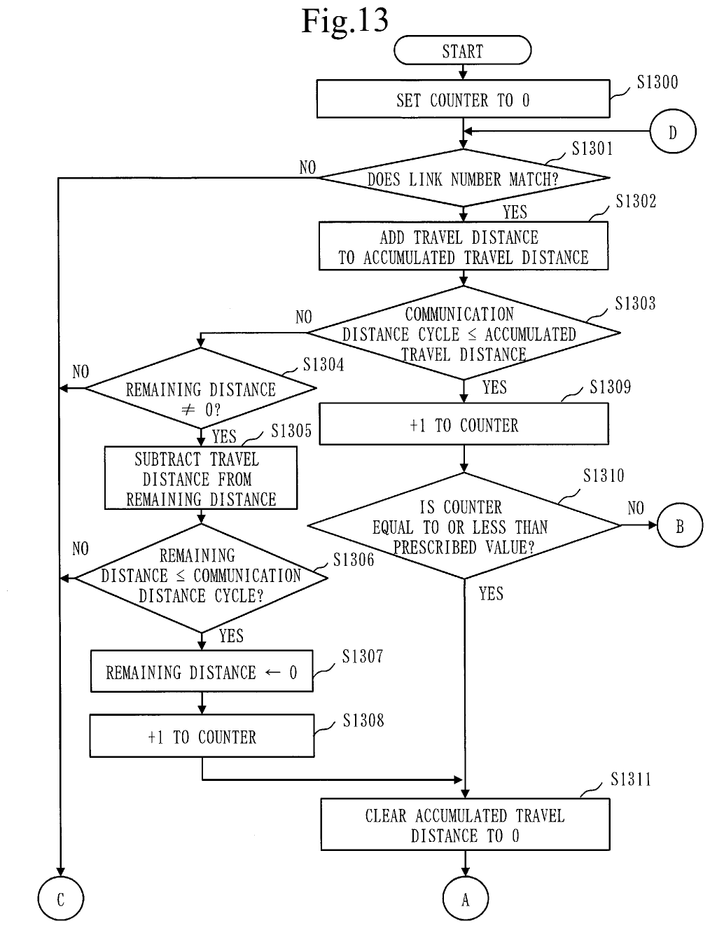

When an application acquires communication data related to a route change (“a detour consideration flag is on”, as described later), it is possible that, if the communication data is acquired immediately before an intersection (a branching point), a route change operation thereafter cannot be performed in time. Therefore, when a communication timing based on travel distance occurs immediately before the intersection, the communication control device 7 revises the communication timing to set it earlier so that distance to the intersection before the intersection is equal to a distance of a communication distance cycle. In accordance with the revised communication timing, the application acquires the communication data (process of steps S1304 to S1308 in FIG. 13, as described later). A zone just before an intersection for which a communication timing is set earlier is called a zone-just-before-intersection.

Based on an assumption above, an example of the functional configuration of the communication control device 7 will be explained.

FIG. 4 illustrates an example of the functional configuration of the communication control device 7.

In FIG. 4, the route registration unit 401 registers in the route storage unit 411, route information that is received from the car navigation device 8. The route registration unit 401 also calls the scheduling unit 403, and generates a schedule.

The in-vehicle LAN communication unit 402, using the in-vehicle LAN interface 304, communicates with the car navigation device 8 and the RSE device 9 via the in-vehicle LAN 10.

The scheduling unit 403 identifies a communication inexecutable zone on a driving route. The scheduling unit 403 also determines a communication distance cycle appropriate to a state of the driving route, and registers the determined communication distance cycle in the schedule storage unit 413. Operation performed by the scheduling unit 403 is called a scheduling process.

The timing process unit 404 notifies the car navigation device 8 and the RSE device 9 of a communication timing via the in-vehicle LAN communication unit 402. And, operation performed by the timing process unit 404 is called a timing process.

The communication request registration unit 405 registers in the communication request storage unit 412, a communication request transmitted by the car navigation device 8 and the RSE device 9. The communication request registration unit 405 also asks the scheduling unit 403 to generate a schedule.

The route storage unit 411 stores the driving route of a moving body received from the car navigation device 8 via the in-vehicle LAN communication unit 402.

The communication request storage unit 412 stores a communication timing request from the car navigation device 8 and the RSE device 9.

The schedule storage unit 413 stores the communication distance cycle determined by the scheduling unit 403.

The position information storage unit 414 stores current position related information received in, for example, one second from the car navigation device 8.

As described above, the route registration unit 401, the in-vehicle LAN communication unit 402, the scheduling unit 403, the timing process unit 404, and the communication request registration unit 405 are realized by the programs. By the CPU 301 executing the programs, the functions of the route registration unit 401, the in-vehicle LAN communication unit 402, the scheduling unit 403, the timing process unit 404, and the communication request registration unit 405 are realized.

And, the route storage unit 411, the communication request storage unit 412, the schedule storage unit 413, and the position information storage unit 414 are realized by the ROM 302 or the RAM 303.

Hereinafter, an example in which the car navigation device 8 transmits current position related information to the communication control device 7 in a one-second cycle will be explained.

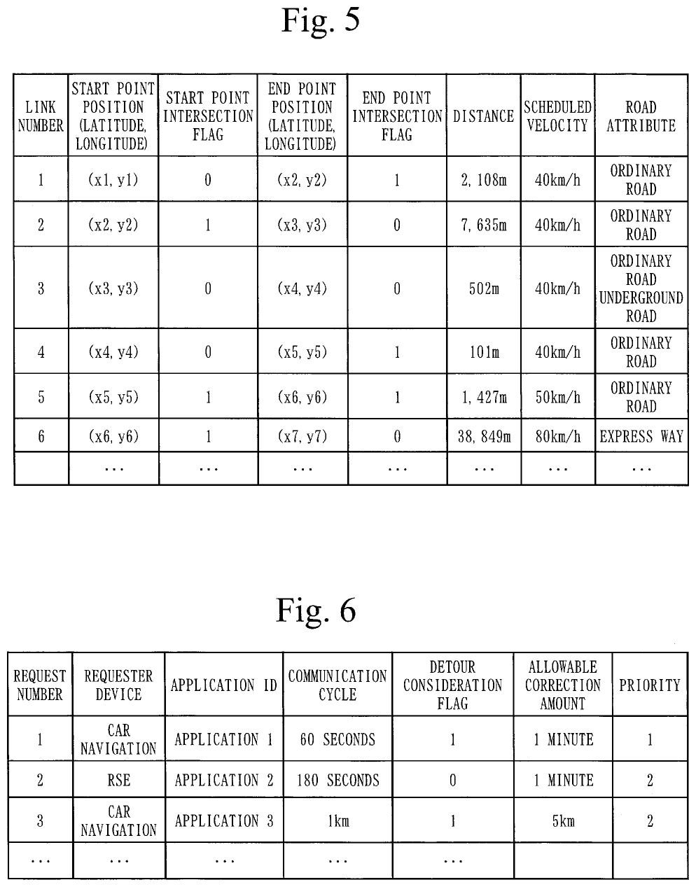

FIG. 5 illustrates an example of a database configuration of the route storage unit 411.

In FIG. 5, each line represents one link that constitutes a driving route. A point of departure of the driving route is a start point position of link number 1, and a destination of the driving route is an end point position of a last line. Also, an end point of link number 1 is consistent with a start point of link number 2.

In each line in FIG. 5, a start point position and an end point position indicate positions of a head and a tail of a link in longitude and latitude.

Each of a start point intersection flag and an end point intersection flag indicates whether or not the start point position and the end point position are branching points of the route, such as an intersection. The start point position or the end point position whose start point intersection flag or end point intersection flag is zero is not the branching point. On the other hand, the start point position or the end point position whose start point intersection flag or the end point intersection flag is one is the branching point.

Distance indicates distance of a path between the start point position and the end point position.

A scheduled velocity indicates a velocity scheduled for traveling from the start point position to the end point position.

A road attribute indicates an attribute of a road from the start point position to the end point position. In specific, the road attribute indicates the attribute of the road, such as an ordinary road, an express way, a tunnel, a massive bridge, or an underground road. Note that a plurality of attributes, such as a tunnel on an ordinary road, may be set as the road attribute.

FIG. 6 illustrates an example of a database configuration of the communication request storage unit 412.

Each line in FIG. 6 represents one communication request.

A request number is an identifier of the communication request.

A requester device is an identifier that uniquely indicates a device connected with the in-vehicle LAN 10 that has made the communication request. As the requester device, for example, an IP address is used.

An application ID is an identifier that uniquely indicates an application that has made the communication request in the requester device. As the application ID, for example, a port number of a TCP or UDP is used.

A communication cycle indicates a communication cycle by a unit of time or by a unit of travel distance applicable in a case where there is no communication inexecutable point on a driving route and communication is carried out in a normal manner.

A detour consideration flag indicates whether or not the application requesting communication has a function to urge detour operation based on data received from the content server 1. If the detour consideration flag is zero, the application does not have the relevant function. On the other hand, if the detour consideration flag is one, the application has the relevant function.

An allowable correction amount indicates amount of correction that is allowable when communication corresponding to the communication request is carried out earlier.

Priority is priority of the communication request. The priority is indicated by one to N. Note that one means highest in priority.

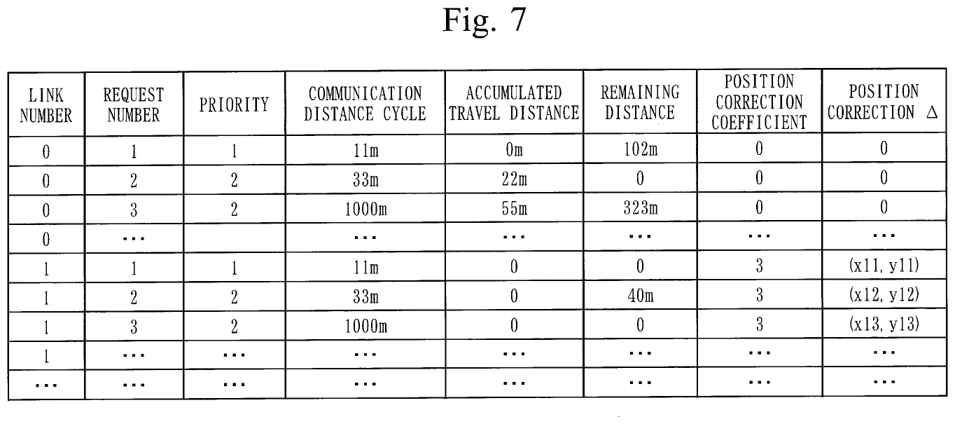

FIG. 7 illustrates an example of a database configuration of the schedule storage unit 413.

A link number is a link number of a driving route.

A request number is a number of a communication request stored in the communication request storage unit 412.

Priority is priority stored in the communication request storage unit 412.

A communication distance cycle is a value of a communication cycle of the communication request converted into travel distance.

Accumulated travel distance is travel distance after a communication timing is transmitted to an application previously.

Remaining distance is remaining distance to an end point position of a link. Note that only when an end point intersection flag of a relevant link is one and a detour consideration flag of the communication request is also one, the remaining distance is available. In any other cases, the remaining distance is zero.

A position correction coefficient and a position correction Δ indicate a correction value of a current position to be specified when an application acquires information from the content server 1 at a next communication timing. The correction value is calculated by multiplying the position correction coefficient by longitude and latitude values of the position correction Δ. Note that, if a correction is not necessary, the position correction coefficient=zero.

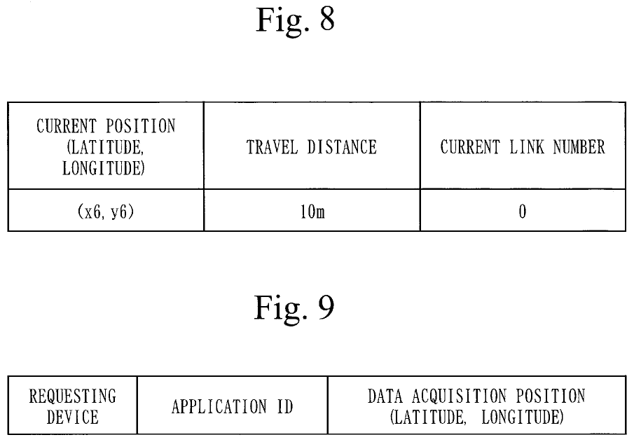

FIG. 8 indicates an example of a database configuration of the position information storage unit 414.

A current position is current position information of a moving body measured by a GPS or the like.

Travel distance is travel distance (distance of a path) in past one second measured by the car navigation device 8.

A current link number indicates a link number of a link to which the current position of the moving body belongs. Note that, if a driving route has not been determined, the current link number is zero.

FIG. 9 illustrates an example of a data configuration of a communication timing notice.

A requesting device is an identifier that indicates a device that has made a communication request to the communication control device 7. As an identifier of the requesting device, for example, an IP address is used.

An application ID is an identifier that uniquely identifies an application that has made the communication request in the requesting device. As the application ID, for example, a TCP port number is used.

A data acquisition position is position information that needs to be specified when the application requests the content server 1 to transmit content data.

### Description of Operation

Next, a description of operation will be given.

First, when a moving body, such as an automobile, starts to drive, power supply to the communication control device 7, the car navigation device 8, and the RSE device 9 is started to activate each of the devices. Then, the car navigation device 8 registers a communication request in the communication control device 7 in order to acquire from the content server, local information on a traffic jam, construction, an accident, and the like around a place where the moving body is currently located.

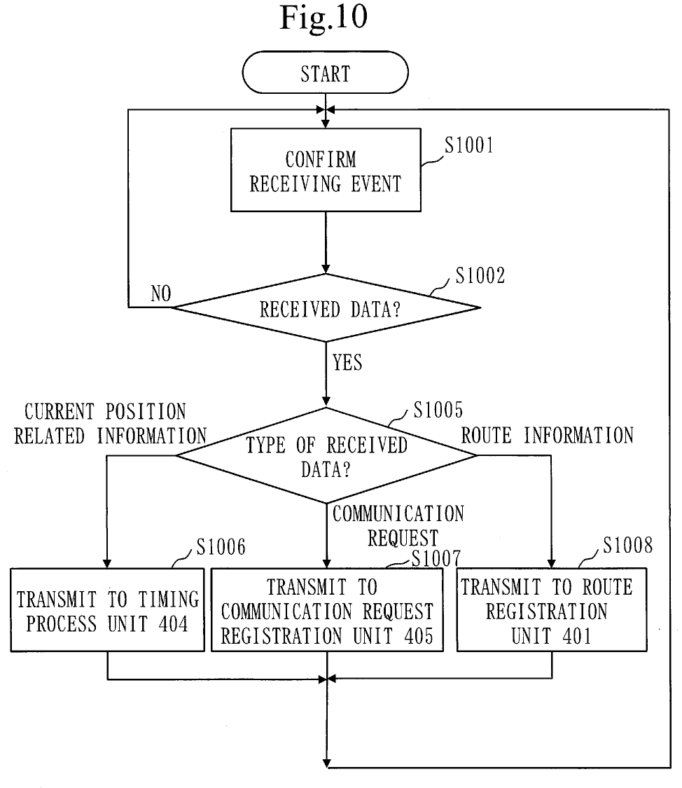

The communication request transmitted by the car navigation device 8 is received by the in-vehicle LAN interface 304, and processed by the in-vehicle LAN communication unit 402 in accordance with a flowchart of FIG. 10.

In step S1001, the in-vehicle LAN communication unit 402 confirms a receiving event of the in-vehicle LAN interface 304.

Upon confirming receipt in step S1002, the in-vehicle LAN communication unit 402 identifies a type of received data in step S1005. Here, since the type of the received data is a communication request, in step S1007, the in-vehicle LAN communication unit 402 transmits the communication request to the communication request registration unit 405.

Here, a process by the in-vehicle LAN communication unit 402 ends.

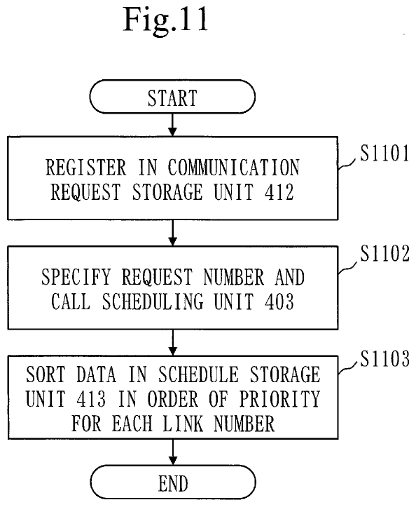

Next, the communication request is processed by the communication request registration unit 405 in accordance with a flowchart of FIG. 11.

Upon receiving the communication request, first in step S1101, the communication request registration unit 405 registers the communication request in the communication request storage unit 412.

Next, in step S1102, the communication request registration unit 405 specifies a communication request number registered in the communication request storage unit 412, and calls the scheduling unit 403. Then, in step S1103, after a process by the scheduling unit 403 ends, the communication request registration unit 405 sorts data in the schedule storage unit 413. The communication request registration unit 405 sorts the data in the schedule storage unit 413 first by link numbers. Next, the communication request registration unit 405 sorts the data in the schedule storage unit 413 in descending order of priority for each data with a same link number. Thus, a process by the communication request registration unit 405 ends.

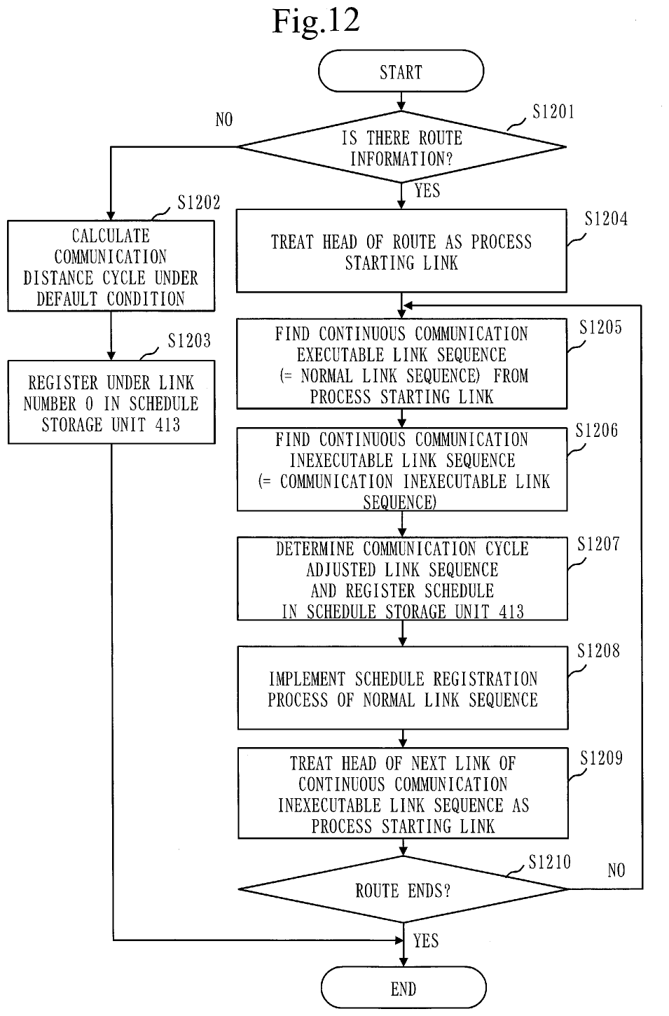

Next, the scheduling unit 403 operates in accordance with a flowchart of FIG. 12.

First, in step S1201, the scheduling unit 403 checks whether a route is registered in the route storage unit 411. Here, since route information is not stored yet, a process proceeds to step S1202. In step S1202, the scheduling unit 403 calculates a communication distance cycle under a default condition applicable when there is no route information. In specific, if a communication cycle is specified in a unit of time such as 60 seconds as request number 1 in FIG. 6, the scheduling unit 403 calculates the communication distance cycle to be 667 meters on an assumption that a traveling velocity is a general speed limit of 40 km/h. Alternatively, if the communication cycle is specified in distance such as one kilometer as request number 3, the scheduling unit 403 specifies that the communication distance cycle is one kilometer as it is. Next, the scheduling unit 403 registers the communication distance cycle calculated in step 1202 together with a request number under link number 0. Note that the scheduling unit 403 registers priority of the communication request for the priority, zero meter for an initial value of the accumulated travel distance, zero meter for the remaining distance, and zero for the position correction coefficient.

Thus, a process at a time when a communication request is received ends.

Note that, though above description is given on a case where the car navigation device 8 makes a communication request, a same process is carried out for a communication request that is made by the RSE device 9.

Next, the car navigation device 8 starts to transmit current position related information to the communication control device 7 in a one-second-cycle. In the communication control device 7, upon receiving the current position related information transmitted by the car navigation device 8, the in-vehicle LAN communication unit 402 carries out a process in accordance with a flowchart of FIG. 10.

In step S1001, the in-vehicle LAN communication unit 402 confirms a receiving event of the in-vehicle LAN interface 304. Upon confirming a receipt in step S1002, the in-vehicle LAN communication unit 402 identifies a type of received data in step S1005. Here, since the type of the received data is current position related information, the in-vehicle LAN communication unit 402 transmits the current position related information to the timing process unit 404 in step S1006.

Here, a process by the in-vehicle LAN communication unit 402 ends.

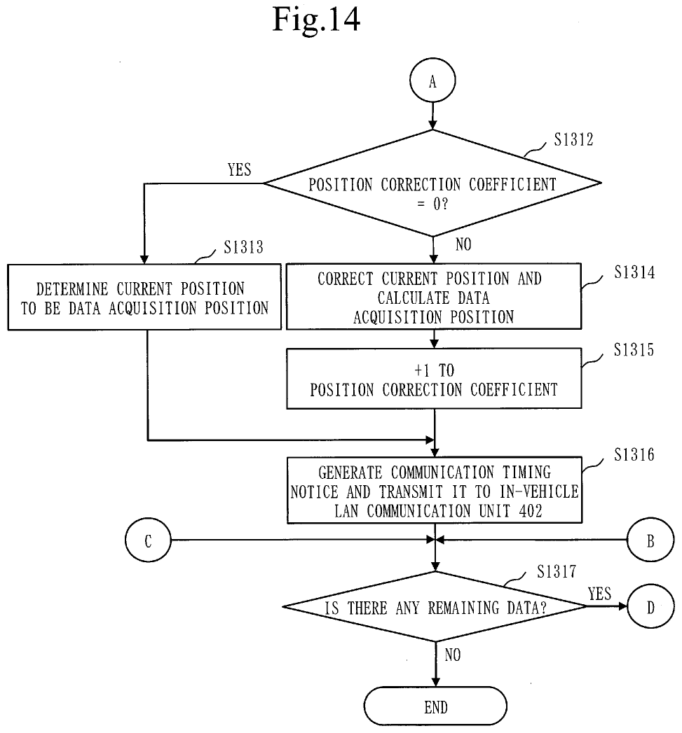

Upon receiving the current position related information, the timing process unit 404 carries out a process in accordance with flowcharts of FIG. 13 and FIG. 14.

First, in step S1300, the timing process unit 404 sets to zero, a counter that indicates number of communication events for which communication is carried out at this timing.

Next, in step S1301, the timing process unit 404 checks whether or not a link number of each data in the schedule storage unit 413 matches a current link number of the current position related information.

In step S1302, if the link number matches the current link number of the current position related information, the timing process unit 404 adds travel distance of the current position related information to accumulated travel distance of relevant data.

Next, if the accumulated travel distance exceeds a communication distance cycle in step S1303, first, in step S1309, the timing process unit 404 adds one to the counter.

Then, in step S1310, the timing process unit 404 checks whether or not a value of the counter is equal to or less than a prescribed value. If the value of the counter exceeds the prescribed value, no more communication event can be set, and therefore, the process proceeds to step S1317. On the other hand, if the value of the counter is equal to or less than the prescribed value, the timing process unit 404 carries out a communication timing notice generation process starting from step S1311.

First, in step S1311, the timing process unit 404 sets the accumulated travel distance to zero.

Next, in step S1312, the timing process unit 404 checks whether or not a position correction coefficient is zero. In an example described above, the position correction coefficient is zero. Therefore, in step S1313, the timing process unit 404 determines a current position of the current position related information to be a data acquisition position. Then, in step S1316, the timing process unit 404 generates a communication timing notice illustrated in FIG. 9, and transmits the generated communication timing notice to the in-vehicle LAN communication unit 402. Note that, if it is determined that the accumulated travel distance is less than the communication distance cycle in step S1303, then in step S1304, the timing process unit 404 checks remaining distance. Since in the example described above, the remaining distance is zero, the process proceeds to step S1317. The timing process unit 404 executes the process described above for all data in the schedule storage unit 413 in step S1317, and ends the process. Then, the in-vehicle LAN communication unit 402 transmits the communication timing notice to a requesting device, and ends the process.

Then, the requesting device that has received the communication timing notice, that is, the car navigation device 8, acquires the data acquisition position, that is, content data regarding the current position, from the content server 1.

Next, when a driver sets a destination on the car navigation device 8, and a driving route is determined on the car navigation device 8, the car navigation device 8 transmits route information to the communication control device 7.

In the communication control device 7, the in-vehicle LAN communication unit 402 processes the route information in accordance with the flowchart of FIG. 10.

In step S1001, the in-vehicle LAN communication unit 402 confirms a receiving event of the in-vehicle LAN interface 304.

Upon confirming receipt in step S1002, the in-vehicle LAN communication unit 402 identifies a type of received data in step S1005.

Here, since the type of the received data is route information, the in-vehicle LAN communication unit 402 transmits the route information to the route registration unit 401 in step S1008.

Here, a process by the in-vehicle LAN communication unit 402 ends.

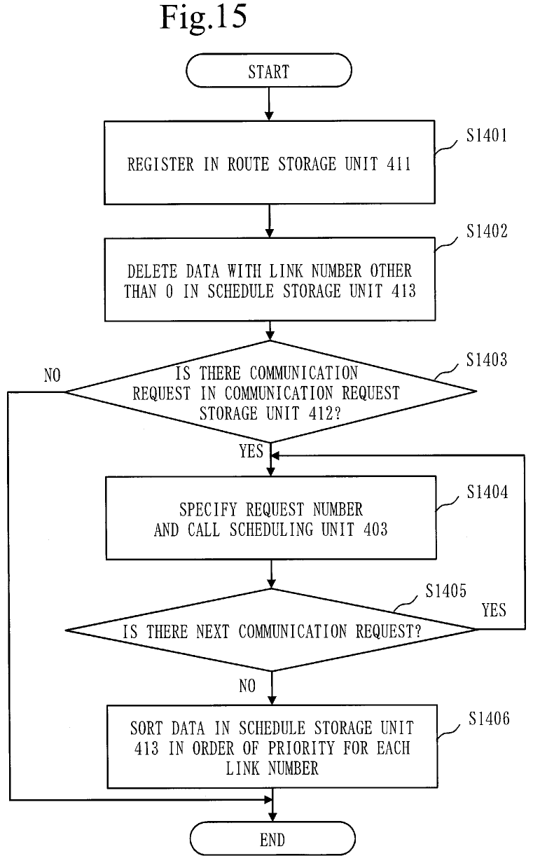

The route registration unit 401 processes the route information in accordance with a flowchart of FIG. 15.

First, in step S1401, the route registration unit 401 stores the route information in the route storage unit 411.

Next, in step S1402, if there is data with a link number other than zero in the schedule storage unit 413, the route registration unit 401 deletes the relevant data.

Next, in step S1403, the route registration unit 401 checks whether or not a communication request is registered in the communication request storage unit 412.

If the communication request is registered, the route registration unit 401 specifies a communication request number for each communication request, and calls the scheduling unit 403, in steps S1404 and S1405.

Then, after a process by the scheduling unit 403 ends, the route registration unit 401 sorts data in the schedule storage unit 413 in step S1406. The route registration unit 401 sorts the data in the schedule storage unit 413 first by link numbers. Next, the route registration unit 401 sorts the data in the schedule storage unit 413 in descending order of priority for each data with a same link number.

Thus, a process by the route registration unit 401 ends.

Next, the scheduling unit 403 executes the process in accordance with the flowchart of FIG. 12.

First, in step S1201, the scheduling unit 403 checks whether or not route information is stored in the route storage unit 411. In the example described above, since the route information is stored in the route storage unit 411, the scheduling unit 403 starts the process from a head of a route in step S1204.

In step S1205, the scheduling unit 403 traces a road attribute of link information in the route storage unit 411 in order, and determines a continuous link sequence for which it is determined that communication can be carried out (normal link sequence). Note that a road attribute for which it is determined that communication can be carried out may be determined by software for the communication control device 7 in advance. Alternatively, the road attribute for which it is determined that communication can be carried out may as well be specifiable by a setting file or the like. Upon coming to a communication inexecutable link, next in step S1206, the scheduling unit 403 determines a continuous communication inexecutable link sequence (communication inexecutable link sequence). The scheduling unit 403 examines road attribute information of the link carefully, and determines the communication inexecutable link sequence, in a same way as the normal link sequence.

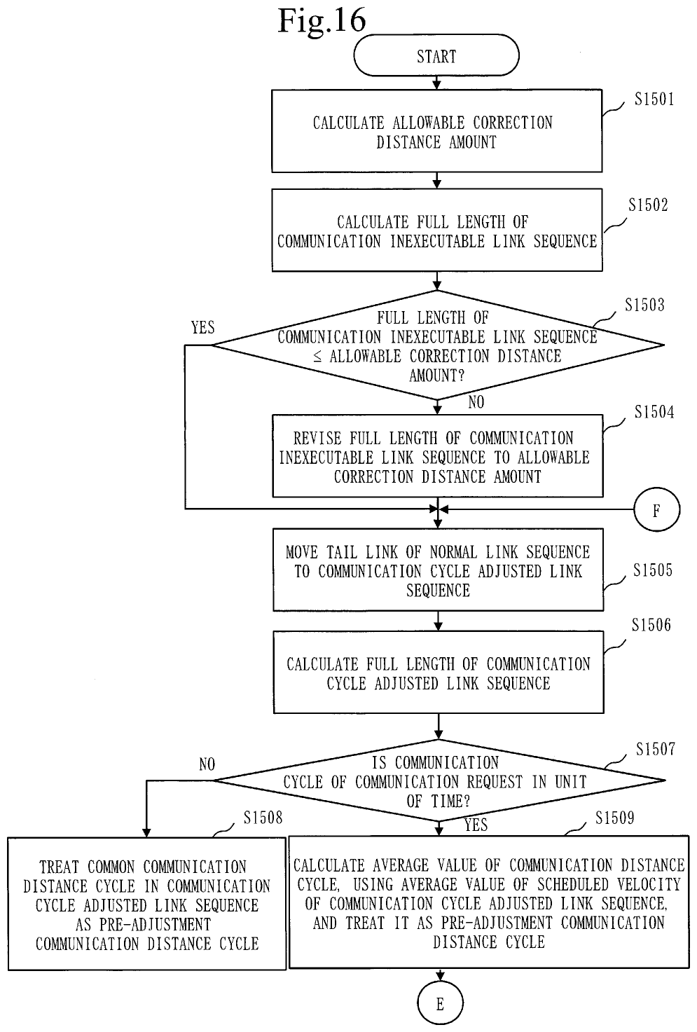

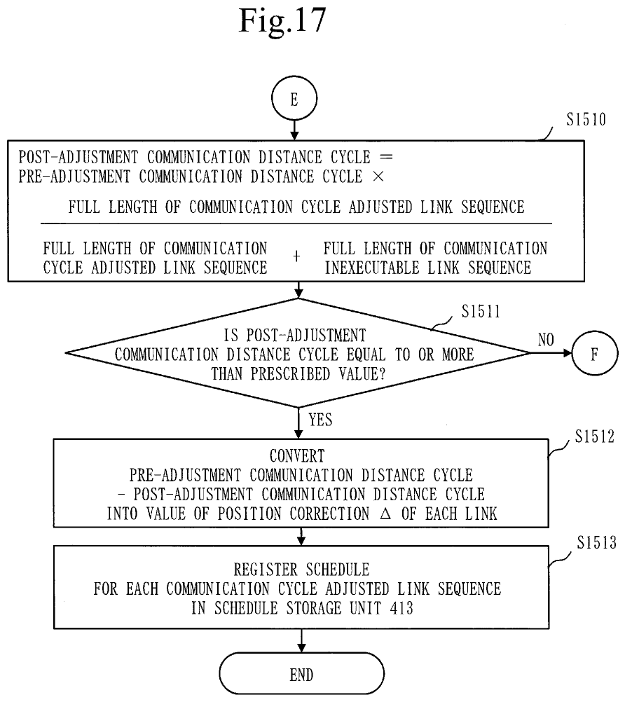

Upon determining the normal link sequence and the communication inexecutable link sequence, the scheduling unit 403 determines a communication cycle adjusted link sequence and then a schedule in step S1207. Details of this process will be explained following flowcharts of FIG. 16 and FIG. 17.

First, in step S1501, the scheduling unit 403 calculates an allowable correction distance amount from an allowable correction amount of the communication request. If the allowable correction amount of the communication request is in a unit of distance, the scheduling unit 403 uses the allowable correction amount as it is. If the allowable correction amount is in a unit of time, the scheduling unit 403 calculates an average value of a scheduled velocity of the communication inexecutable link sequence, and uses a value calculated by multiplying the calculated average value by the allowable correction amount (time), as the allowable correction distance amount.

Next, in step S1502, the scheduling unit 403 calculates a full length of the communication inexecutable link sequence from distance in the route storage unit 411.

Next in step S1503, the scheduling unit 403 compares the allowable correction distance amount with the full length of the communication inexecutable link sequence. If the full length of the communication inexecutable link sequence is longer than the allowable correction distance amount, then in step S1504, the scheduling unit 403 revises the full length of the communication inexecutable link sequence to the allowable correction distance amount.

Next, in step S1505, the scheduling unit 403 moves a tail link of the normal link sequence to a head of the communication cycle adjusted link sequence. In other words, a link sequence that belongs to the normal link sequence becomes shorter by one tail link, and one link is added to the head part of the communication cycle adjusted link sequence.

Next, in step S1506, the scheduling unit 403 calculates a full length of the communication cycle adjusted link sequence.

Next in step S1507, the scheduling unit 403 checks whether or not a communication cycle of a communication request under process is in a unit of time. If the communication cycle of the communication request under process is in the unit of time, then in step S1509, the scheduling unit 403 calculates an average value of scheduled velocities of all links that constitute the communication cycle adjusted link sequence. Then, the scheduling unit 403, by multiplying the calculated average value by the communication cycle, calculates an average value of a communication distance cycle. Then, the scheduling unit 403 uses the calculated average value as a pre-adjustment communication distance cycle.

Alternatively, if the communication cycle is in a unit of distance in step S1507, then in step S1508, the scheduling unit 403 treats the communication cycle as the pre-adjustment communication distance cycle.

Next, in step S1510, the scheduling unit 403 calculates a post-adjustment communication distance cycle by a following formula.

$$Post \text{-} adjustment communcation distance cycle = \begin{matrix}Pre \text{-} adjustment \\ communication \\ distance cycle\end{matrix} \times \frac{Full length of communication cycle adjusted link sequence}{\begin{matrix}Full length of \\ communication \\ cycle adjusted \\ link sequence\end{matrix} + \begin{matrix}Full length of \\ communication \\ inexecutable \\ link sequence\end{matrix}} \qquad [ Formula 1 ]$$

Next, in step S1511, the scheduling unit 403 checks whether or not the calculated post-adjustment communication distance cycle is equal to or more than a prescribed value. Note that the prescribed value may be fixed by software for the communication control process 7, or may be changeable by a setting file or the like.

If the post-adjustment communication distance cycle is shorter than the prescribed value, a communication timing needs to be adjusted in an earlier link. Therefore, the process returns to step S1505. Further, the scheduling unit 403 moves the tail link of the normal link sequence to the communication cycle adjusted link sequence to make readjustment. When the post-adjustment communication cycle is equal to or more than the prescribed value in step S1511, the adjustment of the communication cycle ends, and the process proceeds to step S1512.

In step S1512, the scheduling unit 403 calculates difference between the pre-adjustment communication distance cycle and the post-adjustment communication distance cycle. Then, the scheduling unit 403 calculates a value of a position correction Δ of each link of the communication cycle adjusted link sequence from the calculated difference.

Finally, in step S1513, the scheduling unit 403 registers in the schedule storage unit 413, a schedule for a communication request under process of each link of the communication cycle adjusted link sequence. At this time, the scheduling unit 403 sets to the link number in FIG. 7, each link number of links that belong to the communication process adjusted link sequence. The scheduling unit 403 also sets to the request number and the priority, a request number and priority of the communication request currently under process. The scheduling unit 403 also sets to the communication distance cycle, the post-communication distance cycle. The scheduling unit 403 also sets to the accumulated travel distance, zero meter, sets to the position correction coefficient, one, and sets to the position correction Δ, the value of position correction Δ of each link calculated in step S1512. Also, if a detour consideration flag of the communication request of the request number under process is one and an end point intersection flag of a relevant link is also one, the scheduling unit 403 registers for the remaining distance, (distance of relevant link - scheduled velocity of link x one second). On the other hand, in any other cases, the scheduling unit 403 registers for the remaining distance, zero. Note that one second is a cycle in which the car navigation device 8 transmits current position related information.

The details of step S1207 in FIG. 12 are as described above.

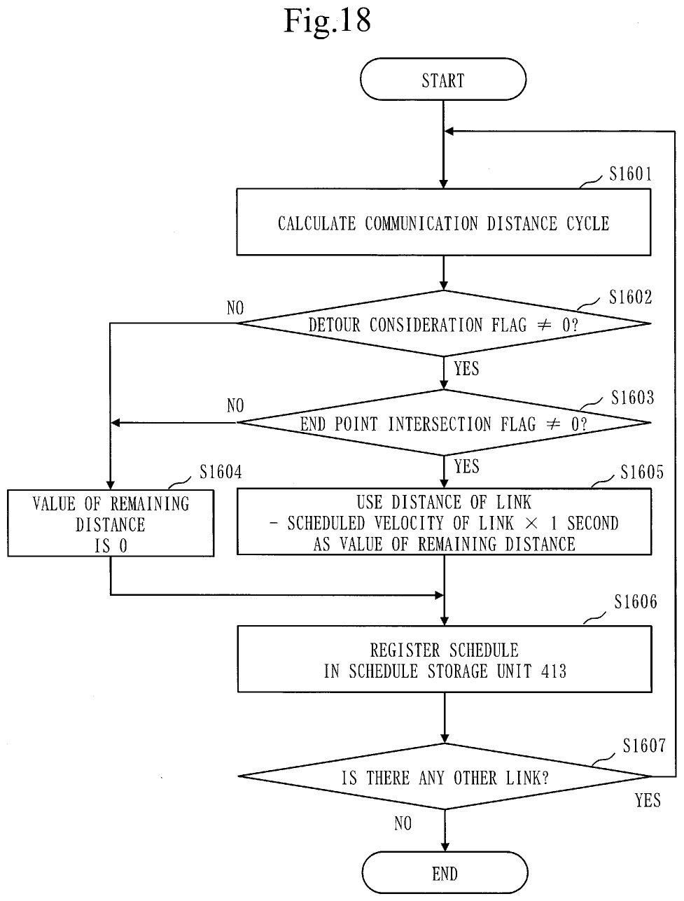

Going back to FIG. 12, the scheduling unit 403 registers a schedule of the normal link sequence in step S1208. Details of this process will be explained following a flowchart of FIG. 18.

First, the scheduling unit 403 calculates a communication distance cycle from the communication cycle of the communication request under process for a head link of the normal link sequence. If the communication cycle is in a unit of distance as request number 3 in FIG. 6, the scheduling unit 403 treats the communication cycle as a communication distance cycle as it is. If the communication cycle is in a unit of time as request number 1 in FIG. 6, the scheduling unit 403 calculates the communication distance cycle by multiplying a scheduled velocity of a relevant link by the communication cycle.

Next, in step S1602, the scheduling unit 403 confirms a detour consideration flag of the communication request. Unless the detour consideration flag is zero, the process proceeds to step S1603, and the scheduling unit 403 confirms an end point intersection flag of the relevant link.

Unless the end point intersection flag is zero, the scheduling unit 403 uses (distance of link−scheduled velocity of link×one second) as the remaining distance. Note that one second is the cycle on which the car navigation device 8 transmits the current position related information.

On the other hand, if the detour consideration flag is zero in step S1602, or the end point intersection flag is zero in step S1603, there is no need to consider a branching point on the route where a detour can be made. Therefore, the scheduling unit 403 sets a value of the remaining distance to zero.

Next, in step S1606, the scheduling unit 403 registers the schedule in the schedule storage unit 413 based on a result described above. At this time, the scheduling unit 403 registers for the link number, a current link number. The scheduling unit 403 also registers for the request number, the request number of the communication request currently under process. The scheduling unit 403 also registers for the priority, the priority of the communication request currently under process. The scheduling unit 403 also registers for the communication distance cycle, the communication distance cycle calculated in step S1601. The scheduling unit 403 also registers for the accumulated travel distance, zero meter. The scheduling unit 403 also registers for the remaining distance, remaining distance determined in step S1604 or step S1605. The scheduling unit 403 also registers for the position correction coefficient, zero, and registers for the position correction Δ, zero.

In step S1607, the scheduling unit 403 executes the process described above for all links of normal link sequence.

The details of step S1208 in FIG. 12 are as described above.

Going back to FIG. 12, a same process as above is carried out also for a remaining part of the route in steps S1209 and S1210, and the process ends.

Thus, operation of the communication control device 7 that is performed at a time when route information is received ends.

When the communication control device 7 receives current position related information sent by the car navigation device 8 in a one-second cycle after this, the in-vehicle LAN communication unit 402 transmits the current position related information to the timing process unit 404 in a completely same way applicable before the route information is received, in accordance with the flowchart of FIG. 10.

Upon receiving the current position related information, the timing process unit 404 carries out a process in accordance with the flowcharts in FIG. 13 and FIG. 14. First, in step S1300, the timing process unit 404 sets a counter to zero.

Next, in step S1301, the timing process unit 404 checks whether a link number of each data in the schedule storage unit 413 matches a current link number of the current position related information.

In step S1302, if the link number matches the current link number of the current position related information, the timing process unit 404 adds travel distance of the current position related information to accumulated travel distance of such data.

If the accumulated travel distance after addition exceeds a communication distance cycle in step S1303, first in step S1309, the timing process unit 404 adds one to the counter.

Next, in step S1310, the timing process unit 404 checks whether or not a value of the counter is equal to or less than a prescribed value. If the value of the counter exceeds the prescribed value, no more communication event can be implemented at this timing, and therefore, the process proceeds to step S1317.

If the value of the counter is equal to or less than the prescribed value, the timing process unit 404 implements a communication timing notice generation process of and after step S1311.

First, in step S1311, the timing process unit 404 sets the accumulated travel distance to zero, and next in step S1312, checks whether or not a position correction coefficient is zero.

If the position correction coefficient is zero, then in step S1313, the timing process unit 404 determines, a current position of the current position related information to be a data acquisition position.

And, if the position correction coefficient is not zero, then in step S1314, the timing process unit 404 adds to the current position information, a value obtained by multiplying a position correction Δ by the position correction coefficient to calculate a position before change in a position of a communication timing that has been changed by adjustment of the communication timing, and treats such position as the data acquisition position.

Next, in step S1315, the timing process unit 404 adds one to the position correction coefficient in the schedule storage unit 413.

Then, in step S1316, the timing process unit 404 generates a communication timing notice illustrated in FIG. 9, and transmits the generated communication timing notice to the in-vehicle LAN communication unit 402.

And, if the accumulated travel distance is less than the communication distance cycle in step S1303, the timing process unit 404 checks remaining distance in step S1304.

Unless the remaining distance is zero, the timing process unit 404 subtracts travel distance from the remaining distance. If the remaining distance becomes equal to or less than the communication distance cycle in step S1306 as a result, distance to a next intersection in a next communication cycle becomes less than a communication request cycle. Therefore, the timing process unit 404 sets the remaining distance to zero in step S1307. Then, in step S1308, the timing process unit 404 adds one to the counter, determines that a communication timing has come earlier, and proceeds with the process to step S1311.

After this, the process of and after step S1311 is implemented in a same way as described above.

The timing process unit 404 executes the process described above for all data in the schedule storage unit 413 in step S1317, and ends the processes. Then, the in-vehicle LAN communication unit 402 transmits the communication timing notice to a requesting device, and ends the process.

Then, the requesting device that has received the communication timing notice, that is, the car navigation device 8 or the RSE device 9, acquires content data regarding a data acquisition position, that is, a current position or a corrected position, from the content server 1.

### Description of Effect of Embodiment

As described above, in the present embodiment, the communication control device 7 provides an application installed in the car navigation device 8 or the RSE device 9 with a communication timing adjusted so that communication for a communication inexecutable zone is implemented in advance. Therefore, according to the present embodiment, a server does not need to carry out communication control for all moving bodies, and accordingly, it is possible to reduce a process of the server.

Also, in the present embodiment, a plurality of applications that are installed in the car navigation device 8 and the RSE device 9 are able to acquire the adjusted communication timing for the communication inexecutable zone by making a communication request to the communication control device 7. Therefore, according to the present embodiment, it is not necessary to carry out communication control being conscious of a route of a moving body for an individual application, and it is possible to reduce a process of the individual application.

Also, in the present embodiment, if the communication for the communication inexecutable zone is carried out in advance, the communication control device 7 notifies the application of a correction value of position information at a time when requesting data from the content server 1, that is, original position information before the communication timing is set earlier. Therefore, according to the present embodiment, even if the application requests the data from the content server 1 in advance avoiding the communication inexecutable zone, the application is able to acquire content data regarding a position in the communication inexecutable zone.

Also, in the present embodiment, a revised communication timing is notified to an application related to a detour or a route change of a moving body. More specifically, if an end point of a link is an intersection, the present embodiment compares remaining distance and a communication distance cycle. Then, if the remaining distance, that is, distance to the intersection, becomes shorter than the communication distance cycle, the communication timing is notified earlier to the application. Therefore, the present embodiment allows the application to ensure sufficient process time before the moving body arrives at the intersection.

Also, the present embodiment provides an application whose communication cycle is in a unit of time with a communication timing after converting a time cycle into travel distance. Therefore, the present embodiment allows an application that processes information periodically in a time cycle in addition to an application whose communication cycle is in a unit of distance to execute communication for the communication inexecutable zone earlier.

Also, if an actual travel velocity of the moving body is slower than a scheduled velocity, a time interval of a communication timing becomes longer. The present embodiment also provides the application whose communication cycle is in the unit of time with a communication timing after converting the time cycle into the travel distance. Therefore, the present embodiment has an effect of reducing congestion of communication even if there are a large number of moving bodies that are carrying out same communication near one another due to a traffic jam.

Also, the present embodiment specifies, for each communication request, a maximum allowable amount of correction that occurs by an earlier communication timing. And, in the present embodiment, earlier communication is not executed that requires correction equal to or more than the maximum allowable amount. Therefore, according to the present embodiment, it is possible to avoid such earlier communication that the application cannot deal with.

Also, the present embodiment specifies number of communication timing notices that are generated per receipt of current position related information in an order of priority of a communication request. Therefore, in the present embodiment, a communication request of low priority is sent at a timing when next current position related information is received. Thus, according to the present embodiment, it is possible to avoid congestion occurring due to overlapping of communication timings of a large number of communication requests.

Note that the present embodiment generates, by comparing remaining distance with a communication distance cycle, a communication timing so as to ensure time corresponding to a communication cycle just before an intersection. However, it is also acceptable that an application specifies time that needs to be ensured before a moving body arrives at the intersection for each communication request, and then the communication control device 7 compares distance corresponding to such time with the remaining distance. In this way, it is possible to ensure process time of the application that is different from the communication cycle before the moving body arrives at the intersection.

### Embodiment 2

Embodiment 1 above realizes an earlier communication timing by shortening a communication interval in a communication zone just before a communication inexecutable zone. Next, in the present embodiment, an example in which communication for the communication inexecutable zone is implemented in the communication zone just before concurrently with normal communication will be given.

Embodiment 2 differs from Embodiment 1 in how to generate a communication timing when the communication timing is set earlier before the communication inexecutable zone.

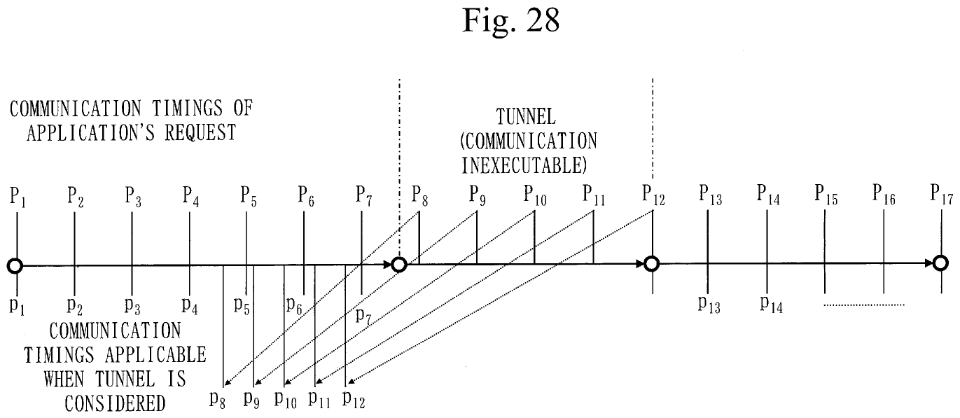

According to Embodiment 1, as illustrated in FIG. 27, the communication control device 7 shortens communication distance cycles P₁ to P₁₂ at a same ratio, and acquires data in order. On the other hand, according to Embodiment 2, as illustrated in FIG. 28, a communication control device 7 sets a communication distance cycle so that communication is carried out in a normal manner for P₁ to P₇ where the communication can be carried out. Also, the communication control device 7 concurrently sets earlier communication distance cycles for P₈ to P₁₂ in the communication inexecutable zone.

By a manner according to the present embodiment, it is possible to acquire information on P₁ to P₇, being positions where communication can be carried out inherently, in a normal way, without difference in time caused by being set earlier, which is different from Embodiment 1.

Mainly, differences from Embodiment 1 will be explained below. Matters not explained below are same as those in Embodiment 1. For example, matters in FIGS. 1 to 6, and FIGS. 8 to 9 are same as those in Embodiment 1.

### Description of Configuration

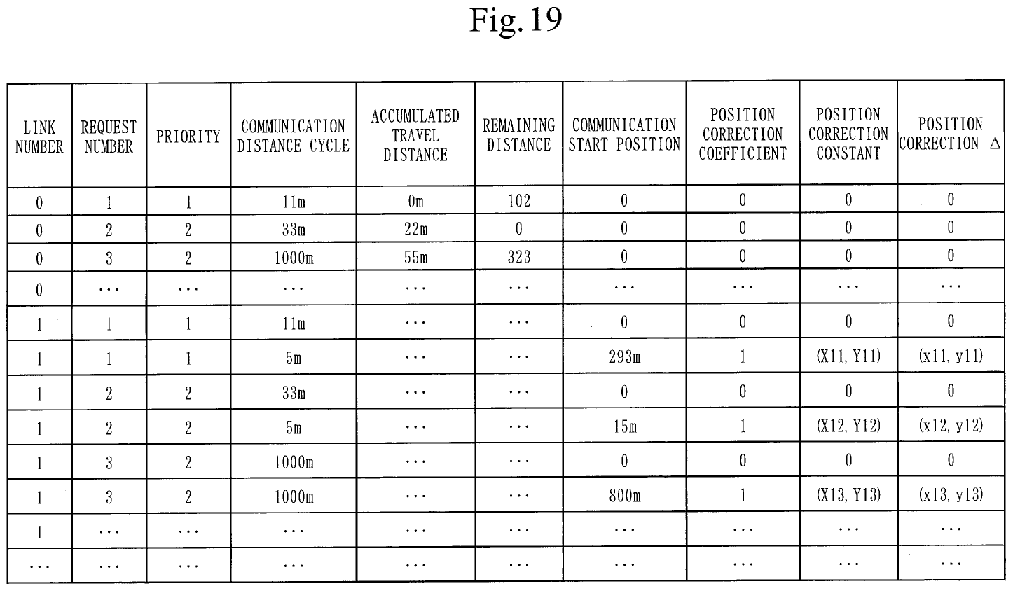

FIG. 19 illustrates an example of a database configuration of a schedule storage unit 413 according to Embodiment 2.

A link number is a link number of a driving route.

A request number is a number of a communication request stored in the communication request storage unit 412.

Priority is priority stored in the communication request storage unit 412.

A communication distance cycle is a value of a communication cycle of the communication request converted into travel distance.

Accumulated travel distance is distance a moving body has traveled after a communication timing is transmitted to an application previously.

Remaining distance is remaining distance to an end point position of a link. Note that only when an end point intersection flag of a relevant link is one and a detour consideration flag of the communication request is one, the remaining distance is available. In any other cases, the remaining distance is zero.

A communication start position is distance from a head of the link at a position where generation of the communication timing is started.

A position correction coefficient, a position correction constant, and a position correction Δ indicate a correction value of a current position to be specified when data is acquired from the content server 1 at a next communication timing. The correction value can be calculated by adding the position correction constant to a value obtained by multiplying longitude and latitude values of the position correction Δ by the position correction coefficient. Note that, if there is no correction, the position correction coefficient=zero.

### Description of Operation

Next, operation will be explained.

Operation according to Embodiment 2 other than that of a scheduling unit 403 and a timing process unit 404 is completely same as that in Embodiment 1. Therefore, only operation of the scheduling unit 403 and the timing process unit 404 will be explained.

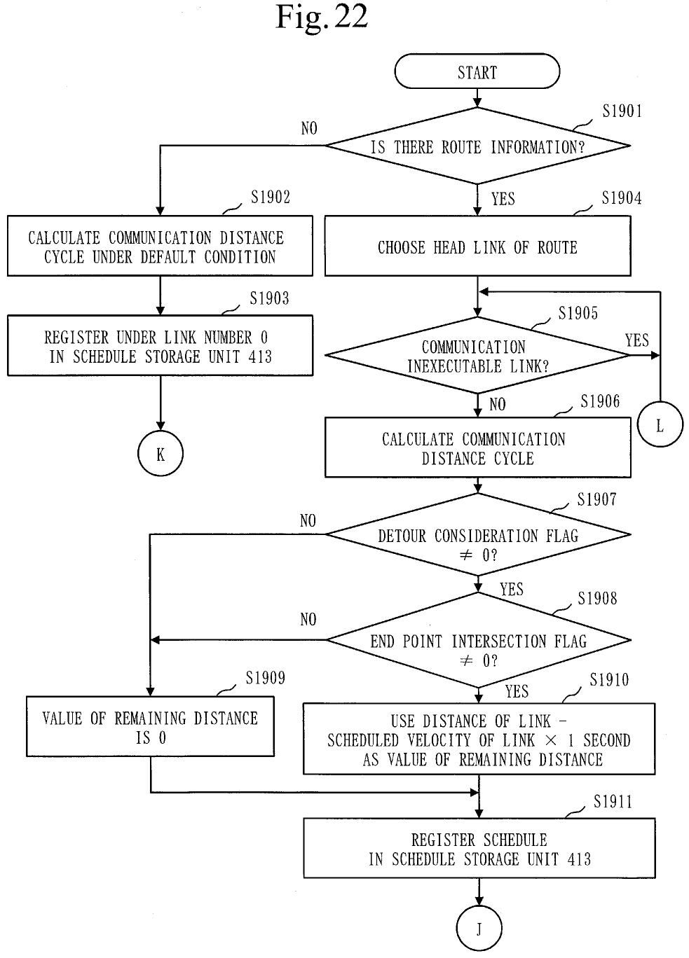

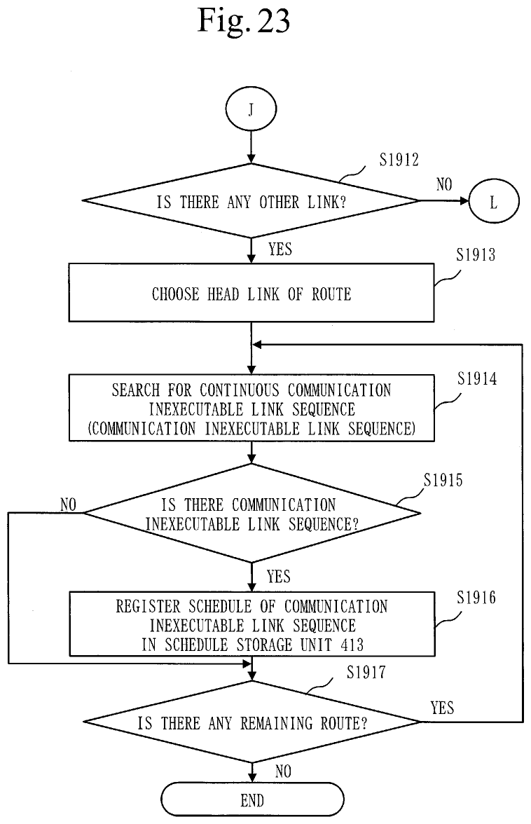

The scheduling unit 403 is called by the route registration unit 401, and generates a schedule from route information. This operation will be explained following flowcharts of FIG. 22 and FIG. 23.

First, in step S1901, the scheduling unit 403 checks whether route information is registered in the route storage unit 411.

If the route information is not registered, then in step S1902, the scheduling unit 403 calculates a communication distance cycle under a default condition applicable when there is no route information. How to calculate a communication distance cycle under the default condition is same as that in Embodiment 1.

Next, in step S1903, the scheduling unit 403 registers the calculated communication distance cycle together with a request number under link number 0. Note that the scheduling unit 403 registers zero meter for an initial value of the accumulated travel distance, zero meter for the remaining distance, zero meter for the communication start position, priority of a communication request for the priority, and zero for the position correction coefficient, the position correction constant, and the position correction Δ.

Next, if the route information is registered in the route storage unit 411 in step S1901, then in step S1904, the scheduling unit 403 starts registration of a normal distance cycle from a head link of a route.

First, in step S1905, the scheduling unit 403 determines from a road attribute, whether a link under process is a communication inexecutable link.

If the link under process is not the communication inexecutable link, then in step S1906, the scheduling unit 403 calculates the communication distance cycle from a communication cycle of the communication request. If the communication cycle is in a unit of distance as request number 3 in FIG. 6, the scheduling unit 403 treats the communication cycle as a communication distance cycle as it is. If the communication cycle is in a unit of time as request number 1 in FIG. 6, the scheduling unit 403 calculates the communication distance cycle by multiplying a scheduled velocity of the relevant link by the communication cycle.

Next, in step S1907, the scheduling unit 403 confirms a detour consideration flag of the communication request.

Unless the detour consideration flag is zero, a process proceeds to step S1908, and the scheduling unit 403 confirms an end point intersection flag of the relevant link.

Unless the end point intersection flag is zero, the scheduling unit 403 uses (distance of link−scheduled velocity of link×one second) as remaining distance in step S1910. Note that one second is a cycle on which the car navigation device 8 transmits current position related information.

On the other hand, if the detour consideration flag is zero in step S1907, or the end point intersection flag is zero in step S1908, there is no need to consider a branching point on the route where a detour can be made. Therefore, the scheduling unit 403 sets a value of the remaining distance to zero in step S1909.

Next, in step S1911, the scheduling unit 403 registers the schedule in the schedule storage unit 413 based on a result described above. At this time, the scheduling unit 403 registers for the link number, a current link number. The scheduling unit 403 also registers for the request number, a request number of the communication request currently under process. The scheduling unit 403 also registers for the priority, priority of the communication request currently under process. The scheduling unit 403 also registers for the communication distance cycle, the communication distance cycle calculated in step S1906. The scheduling unit 403 also registers for the accumulated travel distance, zero meter. The scheduling unit 403 also registers for the remaining distance, the remaining distance determined in step S1909 or S1910. The scheduling unit 403 also registers for the communication start position, the position correction coefficient, and the position correction Δ, zero.

The scheduling unit 403 executes the process described above for all links of the route in step S1912.

Next, from step S1913, the scheduling unit 403 starts registration of an adjusted schedule of a communication inexecutable link.

First, in step S1914, the scheduling unit 403 searches for a sequence of a continuous communication inexecutable link on the route, that is, a communication inexecutable link sequence.

Next, if the communication inexecutable link sequence is found in step S1915, then in step S1916, the scheduling unit 403 registers a schedule of the communication inexecutable link sequence in the schedule storage unit 413.

The scheduling unit 403 implements this process for all routes in step S1917.

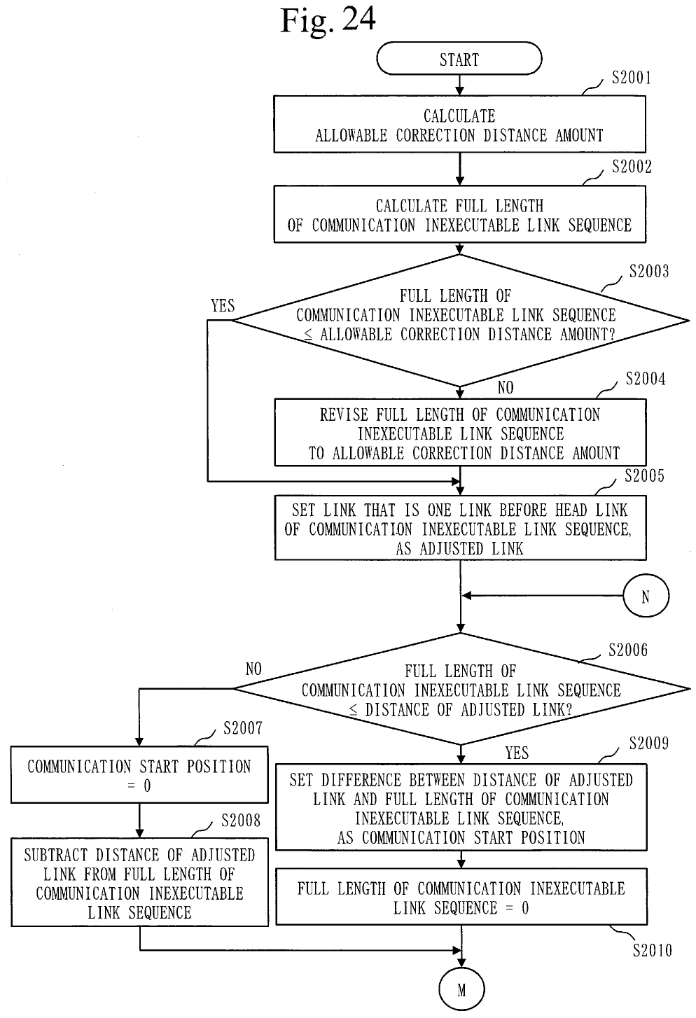

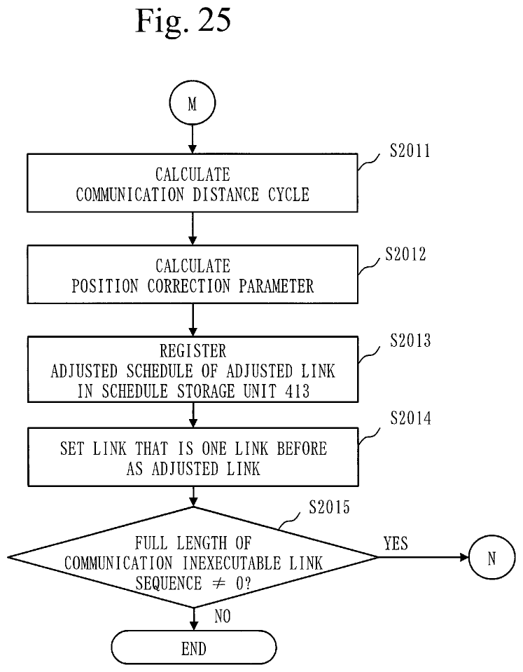

Details of a process of the registration of the schedule of the communication inexecutable link sequence to be implemented in step S1916 will be explained following flowcharts of FIG. 24 and FIG. 25.

First, in step S2001, the scheduling unit 403 calculates an allowable correction distance amount from an allowable correction amount of the communication request. If the allowable correction amount of the communication request is in a unit of distance, the scheduling unit 403 uses the allowable correction amount as it is. If the allowable correction amount is in a unit of time, the scheduling unit 403 calculates an average value of a scheduled velocity of the communication inexecutable link sequence, and uses a value calculated by multiplying the calculated average value by the allowable correction amount (time), as the allowable correction distance amount.

Next, in step S2002, the scheduling unit 403 calculates a full length of the communication inexecutable link sequence from distance in the route storage unit 411.

Next, in step S2003, the scheduling unit 403 compares the allowable correction distance amount with the full length of the communication inexecutable link sequence.

If the full length of the communication inexecutable link sequence is longer than the allowable correction distance amount, then in step S2004, the scheduling unit 403 revises the full length of the communication inexecutable link sequence to the allowable correction distance amount.

Next, in step S2005, the scheduling unit 403 sets as an adjusted link, a link on the route that is one link before a head link of the communication inexecutable link sequence.

Next, in step S2006, the scheduling unit 403 compares distance of the adjusted link with the full length of the communication inexecutable link sequence.

If the full length of the communication inexecutable link sequence is longer, then in step S2007, the scheduling unit 403 sets the communication start position to zero.

Next, in step S2008, the scheduling unit 403 subtracts the distance of the adjusted link from the full length of the communication inexecutable link sequence.

On the other hand, if the full length of the communication inexecutable link sequence is equal to or more than the full length of the communication inexecutable link sequence in step S2006, then in step S2009, the scheduling unit 403 calculates difference between the full length of the communication inexecutable link sequence and the distance of the adjusted link, and sets the obtained value of difference to the communication start position.

Next, in step S2010, the scheduling unit 403 sets the full length of the communication inexecutable link sequence to zero. In other words, the scheduling unit 403 registers that schedule adjustment of all zones of the communication inexecutable link sequence has ended.

Then, in step S2011, the scheduling unit 403 calculates a communication distance cycle. If a communication cycle is in a unit of distance as request number 3 in FIG. 6, the scheduling unit 403 uses the communication cycle as the communication distance cycle as it is. If the communication cycle is in a unit of time as request number 1 in FIG. 6, the scheduling unit 403 calculates the communication distance cycle by multiplying a scheduled velocity of a relevant link by the communication cycle.

Next, in step S2012, the scheduling unit 403 determines a position correction parameter. In specific, the scheduling unit 403 first calculates latitude and longitude of a communication start position of a corrected link. In other words, the scheduling unit 403 calculates latitude, Ax, and longitude, Ay, indicating a point reached by traveling a distance of the communication start position from a start point of the corrected link toward an end point of the corrected link. Next, the scheduling unit 403 calculates latitude, A′x, and longitude, A′y, of the communication inexecutable link sequence corresponding to this point. In other words, the scheduling unit 403 calculates longitude and latitude of a point reached by traveling a distance of the full length of the communication inexecutable link sequence from a start point of a head link of the communication inexecutable link sequence, tracing the link sequence from the start point of the head link of the communication inexecutable link sequence. Next, the scheduling unit 403 treats each of latitude and longitude of the end point of the corrected link as Bx and By. Next, the scheduling unit 403 calculates latitude B′x and longitude B′y of the position of the communication inexecutable link sequence corresponding to the latitude Bx and the longitude By. In other words, the scheduling unit 403 calculates latitude and longitude of a position reached by traveling distance of (full length of communication inexecutable link sequence+distance of corrected link−communication start position) from the start point of the head link of the communication inexecutable link sequence, tracing the link sequence from the start point of the head link of the communication inexecutable link sequence. And then, the scheduling unit 403 performs calculation written below. Note that N=(distance of corrected link−communication start position)/communication distance cycle. Also, it is assumed that a position correction constant is one.

$$Position correction constant = ( {A}^{′} x - Ax , {A}^{′} y - Ay ) \\ Position correction Δ = ( \frac{( {B}^{′} x - Bx ) - ( {A}^{′} x - Ax )}{N} , \frac{( {B}^{′} y - By ) - ( {A}^{′} y - Ay )}{N} ) \qquad [ Formula 2 ]$$

Next, in step S2013, the scheduling unit 403 registers in the schedule storage unit 413 a schedule adjusted for the communication inexecutable link sequence in a part of the adjusted link. In specific, the scheduling unit 403 registers for the link number, a link number of the adjusted link. The scheduling unit 403 also registers for the request number and the priority, a request number and priority of the communication request currently under process. The scheduling unit 403 also registers for the communication distance cycle, the communication distance cycle calculated in step S2012. The scheduling unit 403 also registers for the accumulated travel distance, zero and for the remaining distance, zero. The scheduling unit 403 also registers for the communication start position, the communication start position determined in step S2008 or step S2010. The scheduling unit 403 also registers for the position correction coefficient, the position correction constant, and the position correction Δ, the values determined in step S2012.

Then, in step S2014, the scheduling unit 403 sets as an adjusted link, a link on the route that is one link before the current adjusted link.

Next, in step S2015, the scheduling unit 403 checks whether the full length of the communication inexecutable link is not zero, that is, the adjustment of the schedule has not ended.

If the adjustment of the schedule has not ended, the scheduling unit 403 returns to step S2006, and repeats the process described above until the adjustment of the schedule ends.

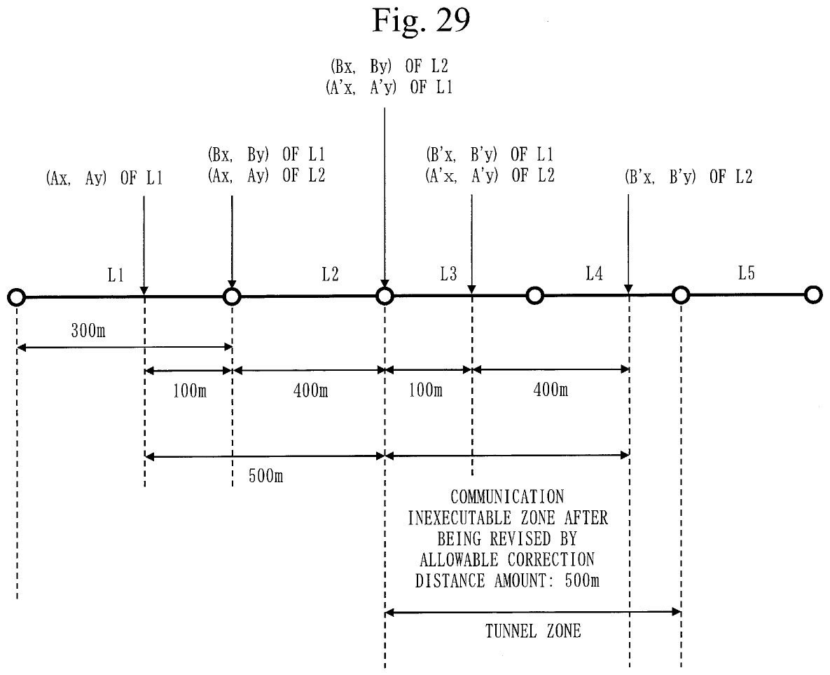

An example in which a process from step S2006 to S2013 is applied to a driving route of FIG. 29 will be explained. Here, it is assumed that the allowable correction distance amount is 500 meters. In this case, since a full length of L3 and L4, which is a tunnel zone, exceeds 500 meters, a full length of a communication inexecutable link zone becomes 500 meters.

First, L2 is processed as a corrected link. Since L2 is 400 meters, it is determined in step S2006 that L2 is shorter than the full length of the communication inexecutable link zone. Therefore, it is determined in step S2007 that a communication start position is zero meter. Then, in step S2008, 400 meter is subtracted from the full length of the communication inexecutable link zone, making the full length of the communication inexecutable link zone be 100 meters.

Next, in step S2011, a communication process cycle is calculated.

Then, in step S2012, a position parameter is calculated. However, since the communication start position is zero meter, each of latitude Ax and longitude Ay of L2 is latitude and longitude of a head position of L2.

Next, latitude A′x and longitude A′y are calculated. At this time, since the full length of the communication inexecutable link zone is 100 meters, latitude and longitude of a position 100 meters ahead from a head of L3, which is a head of the communication inexecutable zone, become latitude A′x and longitude A′y of L2.

Next, each of latitude and longitude of an end point of L2 are calculated to be latitude Bx and longitude By.

Then, latitude B′x and longitude B′y are calculated. Here, since the full length of the communication inexecutable link zone is 100 meters, distance of L2 is 400 meters, and the communication start position is zero meter, a position 500 meters from the head position of L3 along a link becomes an end point of the communication inexecutable zone after correction.

Using values described above, the position correction parameter is determined, and in step S2013, an adjusted schedule is registered in the schedule storage unit 413.

Here, a process of L2 ends, and next, from S2014, a process of L1 starts. In S2015, the full length of a communication inexecutable link sequence is 100 meters, not zero meter. Therefore, it is determined to be necessary to treat L1 as a corrected link, as well.

First, in step S2006, L1 is 300 meters, and longer than 100 meters of the full length of the communication inexecutable link zone. Therefore, in step S2009, the communication start position is set at 200 meters, which is difference between the communication inexecutable link zone and distance of L2. Then, in step S2010, the full length of the communication inexecutable link sequence is set to zero meter.

Next, in step S2011, a communication process cycle is calculated.

Then, in step S2012, a position parameter is calculated. Since the communication start position is 200 meters, each of latitude Ax and longitude Ay of L1 becomes latitude and longitude of a position 200 meters ahead from the head position of L1.

Next, latitude A′x and longitude A′y are calculated. At this time, since the full length of the communication inexecutable link zone has become zero meter, latitude and longitude of the head position of L3, which is the head of the communication inexecutable zone, becomes the latitude A′x and the longitude A′y of L1.

Next, each of latitude and longitude of an end point of L1 are calculated to be latitude Bx and longitude By.

Then, latitude B′x and longitude B′y are calculated. Here, since the full length of the communication inexecutable link zone is zero meter, the distance of L2 is 400 meters, and the communication start position is zero meter, latitude and longitude of a position 100 meters from the head position of L3 along the link becomes the latitude B′x and the longitude B′y of L1.

Using values described above, the position correction parameter is determined, and in step S2013, an adjusted schedule is registered in the schedule storage unit 413.

Here, the process of L1 ends. Since the full length of a communication inexecutable link zone has become zero meter at this point of time, it is determined in step S2015 that a process of the corrected link has ended.

As described above, the scheduling unit 403 implements a process to register a schedule based on route information. Then, operation of the communication control device 7 at a time when route information is received ends.

Next, operation of the timing process unit 404 will be explained.

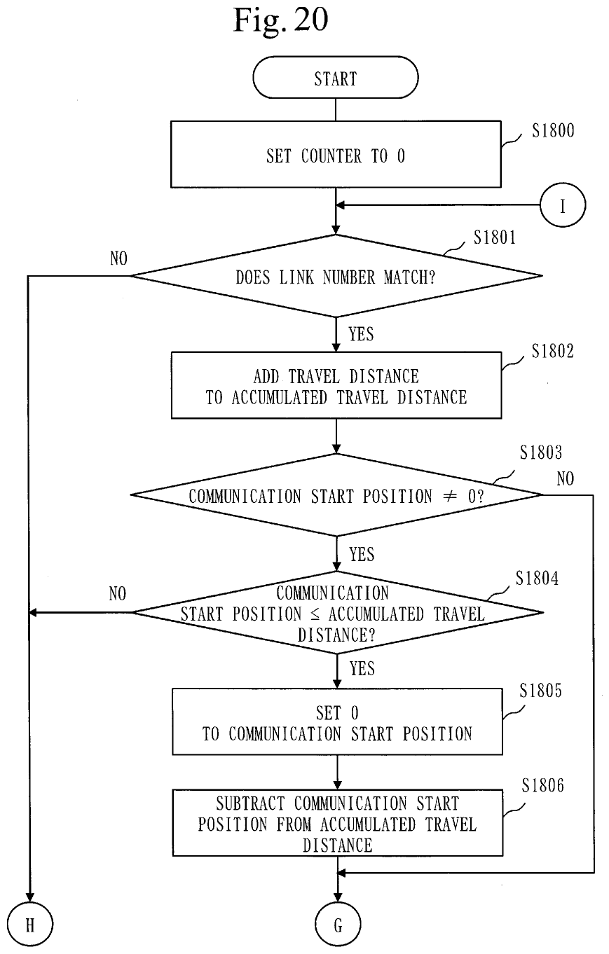

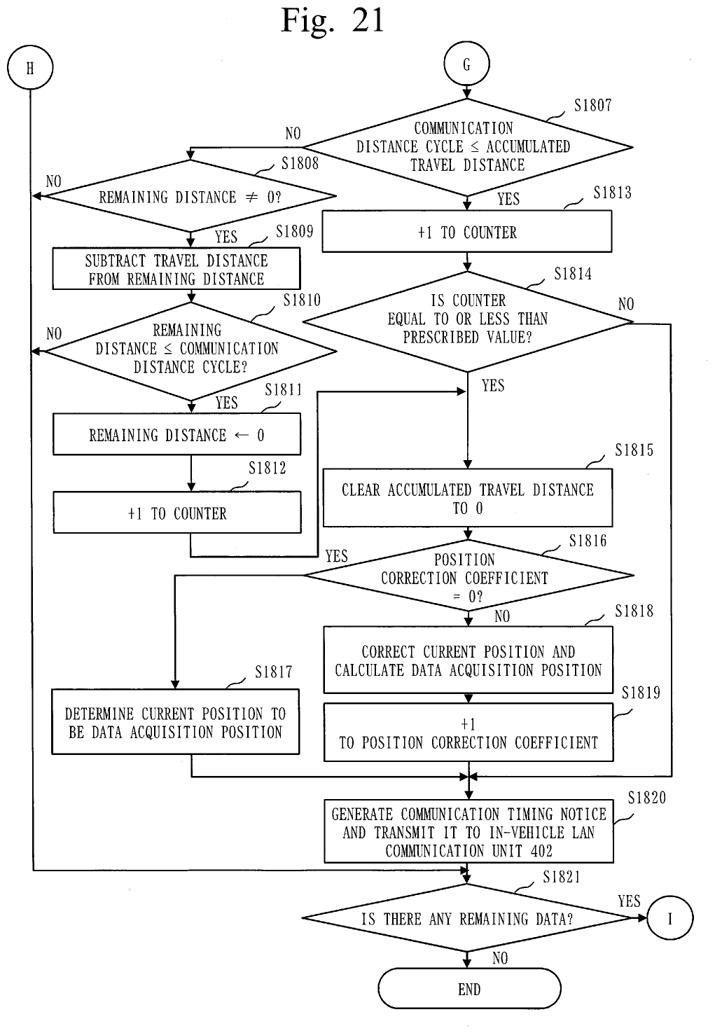

Upon receiving current position related information, the timing process unit 404 carries out a process in accordance with flowcharts in FIG. 20 and FIG. 21.

First, in step S1800, the timing process unit 404 sets to zero, a counter that indicates number of communication events for which communication is carried out.

Next, in step S1801, the timing process unit 404 checks whether a link number of each data in the schedule storage unit 413 matches a current link number of the current position related information.

In step S1802, if the link number matches the current link number of the current position related information, the timing process unit 404 adds travel distance of the current position related information to accumulated travel distance of such data.

Next, in step S1803, the timing process unit 404 checks whether a communication start position is zero. If the communication start position is zero, communication in that link can be started. Therefore, the process proceeds to step S1807.

On the other hand, unless the communication start position is zero, the timing process unit 404 checks, in step S1804, whether the moving body has passed the communication start position.

If the accumulated travel distance is less than the communication start position, the moving body has not passed the communication start position yet. Therefore, the process proceeds to step S1821.

If the accumulated travel distance is equal to or more than the communication start position, the moving body has passed the communication start position. Therefore, the timing process unit 404, first in step S1805, sets zero to the communication start position, and registers that the moving body has passed the communication start position of that link.

Next, in step S1806, the timing process unit 404 subtracts the communication start position from the accumulated travel distance, and registers accumulated travel distance from the communication start position.

Next, if the accumulated travel distance exceeds the communication distance cycle in step S1807, the timing process unit 404, first, in step S1813, adds one to the counter.

Next, in step S1814, the timing process unit 404 checks whether or not a value of the counter is equal to or less than a prescribed value. If the value of the counter exceeds the prescribed value, no more communication event can be set, and therefore, the process proceeds to step S1820.

On the other hand, if the value of the counter is equal to or less than the prescribed value, the timing process unit 404 carries out a generation process of a communication timing notice starting from step S1815.

First, in step S1815, the timing process unit 404 sets the accumulated travel distance to zero.

Next, in step S1816, the timing process unit 404 checks whether or not a position correction coefficient is zero.

If the position correction coefficient is zero, then in step S1817, the timing process unit 404 determines a current position of the current position related information to be a data acquisition position.

And, if the position correction coefficient is not zero, then in step S1818, the timing process unit 404 multiplies a position correction Δ by the position correction coefficient. Further, the timing process unit 404 adds a value calculated by adding the position correction constant to a value multiplied to the current position information to calculate a position before change in a position of a communication timing that has been changed by adjustment of the communication timing, and determines such position to be the data acquisition position.

Next, in step S1819, the timing process unit 404 adds one to the position correction coefficient in the schedule storage unit 413.

Then, in step S1820, the timing process unit 404 generates a communication timing notice illustrated in FIG. 9, and transmits the generated communication timing notice to the in-vehicle LAN communication unit 402.

And, if the accumulated travel distance is less than the communication distance cycle in step S1807, then in step S1808, the timing process unit 404 checks remaining distance.

Unless the remaining distance is zero, the timing process unit 404 subtracts travel distance from the remaining distance. If the remaining distance becomes equal to or less than the communication distance cycle in step S1810 as a result, distance to a next intersection in a next communication cycle becomes less than the communication request cycle. Therefore, in step S1811, the timing process unit 404 sets the remaining distance to zero.

And, in step S1812, the timing process unit 404 adds one to the counter.

Then, the timing process unit 404 determines that a communication timing has come earlier, and the process proceeds to step S1815.

After this, the timing process unit 404 implements the process of and after step S1815 in a same way as described above.

The scheduling unit 403 and the timing process unit 404 operating as described above, it is possible to provide the car navigation device 8 and the RSE device 9 with a communication timing with the content server 1.

### Description of Effect of Embodiment

As described above, in the present embodiment, the communication control device 7 provides an application installed in the car navigation device 8 or the RSE device 9 with a communication timing adjusted so that communication for a communication inexecutable zone is implemented in advance. Therefore, according to the present embodiment, a server does not need to carry out communication control for all moving bodies, and accordingly, it is possible to reduce a process of the server.

Also, in the present embodiment, a plurality of applications that are installed in the car navigation device 8 or the RSE device 9 is able to acquire the adjusted communication timing for the communication inexecutable zone by making a communication request to the communication control device 7. Therefore, according to the present embodiment, it is not necessary to carry out communication control being conscious of a route of a moving body for an individual application, and it is possible to reduce a process of the individual application.

Also, in the present embodiment, if the communication for the communication inexecutable zone is carried out in advance, the communication control device 7 notifies the application of a correction value of position information at a time when requesting data from the content server 1, that is, original position information before the communication timing is set earlier. Therefore, according to the present embodiment, even if the application requests the data from the content server 1 in advance avoiding the communication inexecutable zone, the application is able to acquire content data regarding a position in the communication inexecutable zone.

Also, in the present embodiment, a revised communication timing is notified to an application related to a detour or a route change of a moving body. More specifically, if an end point of a link is an intersection, the present embodiment compares remaining distance and a communication distance cycle. Then, if the remaining distance, that is, distance to the intersection, becomes shorter than the communication distance cycle, the communication timing is notified earlier to the application. Therefore, the present embodiment allows the application to ensure sufficient process time before the moving body arrives at the intersection.

Also, the present embodiment provides an application whose communication cycle is in a unit of time with a communication timing after converting a time cycle into travel distance. Therefore, the present embodiment allows an application that processes information periodically in a time cycle in addition to an application whose communication cycle is in a unit of distance to execute communication for the communication inexecutable zone earlier.

Also, if an actual travel velocity of the moving body is slower than a scheduled velocity, a time interval of a communication timing becomes longer. The present embodiment also provides the application whose communication cycle is in the unit of time with a communication timing after converting the time cycle into travel distance. Therefore, the present embodiment has an effect of reducing congestion of communication even if there are a large number of moving bodies that are carrying out same communication near one another due to a traffic jam.

Also, the present embodiment specifies, for each communication request, a maximum allowable amount of correction that occurs by an earlier communication timing. And, in the present embodiment, earlier communication is not executed that requires correction equal to or more than the maximum allowable amount. Therefore, it is possible to avoid such earlier communication that the application cannot deal with.

Also, the present embodiment specifies number of communication timing notices that are generated per receipt of current position related information in an order of priority of a communication request. Therefore, in the present embodiment, a communication request of low priority is sent at a timing when next current position related information is received. Thus, according to the present embodiment, it is possible to avoid congestion occurring due to overlapping of communication timings of a large number of communication requests.

Note that the present embodiment generates, by comparing remaining distance with a communication distance cycle, a communication timing so as to ensure time corresponding to a communication cycle just before an intersection. However, it is also acceptable that an application specifies time that needs to be ensured before a moving body arrives at the intersection for each communication request, and then the communication control device 7 compares distance corresponding to such time with the remaining distance. In this way, it is possible to ensure process time of the application that is different from the communication cycle before the moving body arrives at the intersection.

The embodiments of the present invention are explained above. However, these two embodiments may be implemented in combination.

Alternatively, one of these two embodiments may be implemented partly.

Alternatively, these two embodiments may be implemented partly in combination.

Note that the present invention is not limited to these embodiments, and may be changed in various ways as necessary.

### Description of Hardware Configuration

Finally, a supplementary explanation of a hardware configuration of the communication control device 7 will be given.

The ROM 302 stores an operation system (OS).

And, at least a part of the OS is executed by the CPU 301.

The CPU 301 implements programs to realize functions of the route registration unit 401, the in-vehicle LAN communication unit 402, the scheduling unit 403, the timing process unit 404, and the communication request registration unit 405 while executing at least a part of the OS.

By the CPU 301 executing the OS, task management, memory management, file management, communication control, and the like are carried out.

At least any of information, data, a signal value and a variable value that indicates a result of a process of the route registration unit 401, the in-vehicle LAN communication unit 402, the scheduling unit 403, the timing process unit 404, and the communication request registration unit 405 is stored in at least any of the ROM 302, the RAM 303, and a register and a cache memory in the CPU 301.

Also, the programs that realize the functions of the route registration unit 401, the in-vehicle LAN communication unit 402, the scheduling unit 403, the timing process unit 404, and the communication request registration unit 405 may be stored in a portable storage medium, such as a magnetic disk, a flexible disk, an optical disc, a compact disc, a Blu-ray (a registered trademark) disc, and a DVD.

Also, “unit” of the route registration unit 401, the in-vehicle LAN communication unit 402, the scheduling unit 403, the timing process unit 404, or the communication request registration unit 405 may be replaced by a “circuit”, a “step”, a “procedure”, or a “process”.

Also, the communication control device 7 may be realized by a processing circuit. The processing circuit is, for example, a logic integrated circuit (IC), a gate array (GA), an application-specific integrated circuit (ASIC), or a field-programmable gate array (FPGA).

In this case, each of the route registration unit 401, the in-vehicle LAN communication unit 402, the scheduling unit 403, the timing process unit 404, and the communication request registration unit 405 is realized as a part of the processing circuit.

Note that, in this description, a broader concept of a processor, a memory, a combination of the processor and the memory, and the processing circuit is called as “processing circuitry”.

In other words, each of the processor, the memory, the combination of the processor and the memory, and the processing circuit is an example of the “processing circuitry”.

### REFERENCE SIGNS LIST

1: content server; 2: moving body; 2a: moving body; 2b: moving body; 2c: moving body; 3: public network; 4a: driving route; 4b: driving route; 4c: driving route; 5a: point of departure; 5b: point of departure; 5c: point of departure; 6a: destination; 6b: destination; 6c: destination; 7: communication control device; 8: car navigation device; 9: RSE device; 10: in-vehicle LAN; 301: CPU; 302: ROM; 303: RAM; 304: in-vehicle LAN interface; 401: route registration unit; 402: in-vehicle LAN communication unit; 403: scheduling unit; 404: timing process unit; 405: communication request registration unit; 411: route storage unit; 412: communication request storage unit; 413: schedule storage unit; 414: position information storage unit

1-12. (canceled)

13. A communication control device mounted on a moving body in which a plurality of application programs to communicate with an external device are deployed, the communication control device comprising:
processing circuitry to:
schedule for each of the application programs, using a position on a traveling route of the moving body, a communication timing at which each of the application programs communicates with the external device, based on a communication distance cycle and the traveling route, the communication distance cycle being a distance cycle prescribed for each of the application programs and applicable when each of the application programs communicates with the external device, and
determine for each of the application programs, whether or not the moving body has arrived at a position of the communication timing, and when the moving body arrives at the position of the communication timing for any of the application programs, to notify a corresponding application program that the communication timing has come,
wherein the processing circuitry sets for each of the application programs, the position of the communication timing in accordance with the communication distance cycle of each of the application programs, if there is a communication inexecutable zone on the traveling route, the communication inexecutable zone being a zone where communication by the plurality of application programs with the external device cannot be carried out, determines for each of the application programs whether or not the position of the communication timing is set in the communication inexecutable zone, and if there is an application program for which the position of the communication timing is set in the communication inexecutable zone, changes for the application program, the position of the communication timing set in the communication inexecutable zone to a position just before the communication inexecutable zone.

14. The communication control device according to claim 13,
wherein the processing circuitry notifies, when the moving body arrives at the position of the communication timing for any of the application programs, a corresponding application program that the communication timing has come, and also notifies, if the position of the communication timing has not been changed, the corresponding application program of the position of the communication timing and, if the position of the communication timing has been changed, the corresponding application program of a position of the communication timing before change.

15. The communication control device according to claim 13,
wherein if there is an application program for which a plurality of positions of the communication timing are set in the communication inexecutable zone, the processing circuitry changes for the application program, the plurality of positions of the communication timing set in the communication inexecutable zone to a plurality of positions just before the communication inexecutable zone.

16. The communication control device according to claim 13,
wherein if there is an application program for which the position of the communication timing is set in the communication inexecutable zone, the processing circuitry sets the position of the communication timing in a communication executable zone just before the communication inexecutable zone using a distance cycle shorter than the communication distance cycle so as to change for the application program, the position of the communication timing set in the communication inexecutable zone to a position in the communication executable zone.

17. The communication control device according to claim 13,
wherein if there is an application program for which the position of the communication timing is set in the communication inexecutable zone, the processing circuitry changes for the application program, the position of the communication timing set in the communication inexecutable zone to the position in the communication executable zone without changing the position of the communication timing in the communication executable zone just before the communication inexecutable zone.

18. The communication control device according to claim 13,
wherein the processing circuitry sets for each of the application programs, the position of the communication timing in accordance with a communication distance cycle of each of the application programs, if there is an intersection on the traveling route, determines for each of the application programs whether or not the position of the communication timing is set in a zone-just-before-intersection, the zone-just-before-intersection being a zone just before the intersection within prescribed distance from the intersection, and if there is an application program for which the position of the communication timing is set in the zone-just-before-intersection, changes for the application program, the position of the communication timing set in the zone-just-before-intersection to a position just before the zone-just-before-intersection.

19. The communication control device according to claim 13,
wherein the processing circuitry does not change the position of the communication timing set in the communication inexecutable zone when there is an application program for which the position of the communication timing is set in the communication inexecutable zone and if amount of change exceeds a threshold when the position of the communication timing set in the communication inexecutable zone is changed to the position just before the communication inexecutable zone, for the application program.

20. The communication control device according to claim 18,
wherein the processing circuitry does not change the position of the communication timing set in the zone-just-before-intersection, if there is an application program for which the position of the communication timing is set in the zone-just-before-intersection and if amount of change exceeds a threshold when the position of the communication timing set in the zone-just-before-intersection is changed to the position just before the zone-just-before-intersection, for the application program.

21. The communication control device according to claim 13,
wherein if a same position is set as the position of the communication timing for two or more application programs, the processing circuitry selects a prescribed number of application programs in descending order of priority among those two or more application programs, and notifies only a selected application that the communication timing has come.

22. A communication control method comprising:
a scheduling process by a computer mounted on a moving body in which a plurality of application programs to communicate with an external device are deployed, of scheduling, for each of the application programs, using a position on a traveling route of the moving body, a communication timing at which each of the application programs communicates with the external device, based on a communication distance cycle and the traveling route, the communication distance cycle being a distance cycle prescribed for each of the application programs and applicable when each of the application programs communicates with the external device; and
a timing process by the computer, of determining, for each of the application programs, whether or not the moving body has arrived at a position of the communication timing, and when the moving body arrives at the position of the communication timing for any of the application programs, notifying a corresponding application program that the communication timing has come,
wherein in the scheduling process, the computer sets for each of the application programs, the position of the communication timing in accordance with the communication distance cycle of each of the application programs, if there is a communication inexecutable zone on the traveling route, the communication inexecutable zone being a zone where communication by the plurality of application programs with the external device cannot be carried out, determines for each of the application programs whether or not the position of the communication timing is set in the communication inexecutable zone, and if there is an application program for which the position of the communication timing is set in the communication inexecutable zone, changes for the application program, the position of the communication timing set in the communication inexecutable zone to a position just before the communication inexecutable zone.

23. A non-transitory computer readable medium storing a communication control program that:
causes a computer mounted on a moving body in which a plurality of application programs to communicate with an external device are deployed to execute:
a scheduling process of scheduling, for each of the application programs, using a position on a traveling route of the moving body, a communication timing at which each of the application programs communicates with the external device, based on a communication distance cycle and the traveling route, the communication distance cycle being a distance cycle prescribed for each of the application programs and applicable when each of the application programs communicates with the external device; and
a timing process of determining, for each of the application programs, whether or not the moving body has arrived at a position of the communication timing, and when the moving body arrives at the position of the communication timing for any of the application programs, notifying a corresponding application program that the communication timing has come; and
causes the computer, in the scheduling process, to set for each of the application programs, the position of the communication timing in accordance with the communication distance cycle of each of the application programs, if there is a communication inexecutable zone on the traveling route, the communication inexecutable zone being a zone where communication by the plurality of application programs with the external device cannot be carried out, to determine for each of the application programs whether or not the position of the communication timing is set in the communication inexecutable zone, and if there is an application program for which the position of the communication timing is set in the communication inexecutable zone, to change for the application program, the position of the communication timing set in the communication inexecutable zone to a position just before the communication inexecutable zone.
